(19) United States
(12) Patent Application Publication
(10) Pub. No.: US 2026/0180863 A1
(43) Pub. Date: Jun. 25, 2026

(54) PROVISIONING OF POLICIES FOR O-CLOUD ORCHESTRATION AND MANAGEMENT

(71) Applicant: RAKUTEN MOBILE, INC., Setagaya-ku, Tokyo (JP)

(72) Inventors: Pankaj Tanaji SHETE, Tokyo (JP); Awn MUHAMMAD, Tokyo (JP); Manmeet Singh BHANGU, Tokyo (JP)

(73) Assignee: RAKUTEN MOBILE, INC., Setagaya-ku, Tokyo (JP)

(21) Appl. No.: 18/848,587

(22) PCT Filed: Jun. 20, 2024
(86) PCT No.: PCT/US2024/034648

§ 371 Date: Sep. 19, 2024

(30) Foreign Application Priority Data
Jun. 19, 2023 (IN) 202341041458

(51) Int. Cl. H04L 41/0894; H04L 41/0823; H04L 41/0897; H04L 41/14

(52) U.S. Cl. CPC H04L 41/0894; H04L 41/0823; H04L 41/0897; H04L 41/14

(57) ABSTRACT

Example embodiments of the present disclosure relate to the provisioning of a policy for O-Cloud orchestration and management. According to example embodiments, a system may include a Non-RT RIC. The Non-RT RIC may be configured to generate a policy associated with an O-Cloud and provide the policy to at least one of an NFO and a FOCOM. The policy may be executable by the NFO/FOCOM for managing and orchestrating the O-Cloud, and may include at least one of: a capacity policy associated with a resource management operation associated with the O-Cloud, a scaling policy associated with a scaling operation associated with the O-Cloud, an energy-saving policy associated with an energy-saving operation associated with the O-Cloud and a healing policy associated with a healing operation associated with the O-Cloud.

### CROSS REFERENCE TO RELATED APPLICATION

This application claims priority to Indian Provisional Patent Application No. 202341041458 filed with the Indian Patent Office on Jun. 19, 2023, the entire contents of which are incorporated herein by reference.

### TECHNICAL FIELD

The present disclosure relates to the provisioning of a policy for open RAN (O-RAN) cloud (O-Cloud) orchestration and management.

### BACKGROUND

The information disclosed in this background section is only for the enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor-specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based, etc.), or could be in physical hardware form (e.g., non-VM based, etc.) Accordingly, O-RAN disaggregates the RAN functions into different entities, such as a central unit (CU), a distributed unit (DU), and a radio unit (RU). The RAN functions may be controlled by at least one RAN intelligent controller (RIC), such as a non-real-time (Non-RT) RIC and a near-real-time (Near-RT) RIC. Since these entities have open protocols and interfaces between them, they can be developed by different vendors.

In addition, an O-RAN cloud (O-Cloud) may be utilized in the O-RAN architecture. The O-Cloud may refer to a cloud computing platform comprising a collection of physical infrastructure nodes that meet O-RAN requirements to host the relevant O-RAN NEs or functions (e.g., Near-RT RIC, CU, DU, etc.), the supporting software components (e.g., operating system, virtual machine monitor, container runtime, etc.), and the appropriate management orchestration function.

### SUMMARY

Example embodiments of the present disclosure provide systems, apparatuses, methods, and the like, that facilitate the provisioning of a policy for O-Cloud orchestration and management.

According to example embodiments, a system may include a Non-RT RIC. The Non-RT RIC may be configured to generate a policy associated with an O-Cloud and provide the policy to at least one of a network function orchestrator (NFO) and a federated O-Cloud orchestration and management entity (FOCOM). The policy may be executable by the NFO/FOCOM for managing and orchestrating the O-Cloud, and may include at least one of: a capacity policy associated with a resource management operation associated with the O-Cloud, a scaling policy associated with a scaling operation associated with the O-Cloud, an energy-saving policy associated with an energy-saving operation associated with the O-Cloud, and a healing policy associated with a healing operation associated with the O-Cloud.

According to example embodiments, a method may include: generating a policy associated with an O-Cloud and providing the policy to at least one of an NFO and a FOCOM. The policy may be executable by the NFO/FOCOM for managing and orchestrating the O-Cloud, and may include at least one of: a capacity policy associated with a resource management operation associated with the O-Cloud, a scaling policy associated with a scaling operation associated with the O-Cloud, an energy-saving policy associated with an energy-saving operation associated with the O-Cloud, and a healing policy associated with a healing operation associated with the O-Cloud.

According to example embodiments, a non-transitory computer-readable recording medium having recorded thereon instructions executable by a system that includes a Non-RT RIC to cause the Non-RT RIC to perform a method including: generating a policy associated with an O-Cloud and providing the policy to at least one of an NFO and a FOCOM. The policy may be executable by the NFO/FOCOM for managing and orchestrating the O-Cloud, and may include at least one of: a capacity policy associated with a resource management operation associated with the O-Cloud, a scaling policy associated with a scaling operation associated with the O-Cloud, an energy-saving policy associated with an energy-saving operation associated with the O-Cloud, and a healing policy associated with a healing operation associated with the O-Cloud.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an open radio access network (O-RAN) architecture in which one or more example embodiments of the present disclosure may be implemented;

FIG. 2 illustrates a block diagram of an example O-Cloud policy, according to one or more example embodiments;

FIG. 3 illustrates a block diagram that illustrates various types of O-Cloud policy, according to one or more example embodiments;

FIG. 4 illustrates a graph of an example use case in which an NF predictive auto-scaling policy is involved in a scaling operation, according to one or more example embodiments;

FIG. 5 illustrates a block diagram of an example auto-scaling group defined by a scaling policy, according to one or more embodiments;

FIG. 6 illustrates graphs of an example use case in which an energy-saving policy is involved in an energy-saving operation, according to one or more example embodiments;

FIG. 7 illustrates a flow diagram of an example use case in which a healing policy is involved in a healing operation according to one or more example embodiments;

FIG. 8 illustrates a flow diagram of an example method for provisioning one or more O-Cloud policies, according to one or more example embodiments; and

FIG. 9 illustrates a device for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “O-Cloud”, “NFO”, “FOCOM”, “SME”, “PMI”, “rApp”, “xApp”, “A1 interface”, “A2 interface”, “A1 policy”, “E2 interface”, “O1 interface”, “O2 interface”, and the like, as well as the associated features and operations, are to be interpreted as consistent with those specified in one or more technical specifications, unless being described otherwise.

With the evolvement in telecommunication network technologies, the RAN may be disaggregated into multiple nodes or entities. Specifically, in the O-RAN architecture, the RAN functions may be disaggregated into multiple logical nodes or entities, such as a central unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. A single DU may host or serve multiple network cells formed by multiple RUs. The RU may be a physical node that converts radio signals from antennas to digital signals that can be transmitted over the Front Haul to a DU. In this regard, a network cell may correspond to one or more radio units responsible for providing wireless coverage and signal transmission within the network cell. To this end, since the disaggregated entities have open protocols and interfaces between them, they can be developed by different vendors.

The RAN functions may be controlled by at least one RAN intelligent controller (RIC), such as a non-real-time (Non-RT) RIC and a near-real-time (Near-RT) RIC. The non-RT RIC resides in a Service Management and Orchestration (SMO) framework and may be configured to support non-real-time radio resource management, policy optimization in RAN, and providing guidance, parameters, and policies, to support operations of the near-RT RIC to achieve higher-level non-real-time objectives. The SMO may have access to data other than that available in RAN network functions, which can be used to enhance RAN optimization functions.

An O-RAN cloud (O-Cloud) may be utilized in the O-RAN architecture. In this regard, the O-Cloud may refer to a cloud computing platform comprising a collection of physical infrastructure nodes that meet O-RAN requirements to host the relevant O-RAN NEs or functions (e.g., near-RT RIC, CU, DU, etc.), the supporting software components (e.g., operating system, virtual machine monitor, container runtime, etc.), and the appropriate management orchestration function.

The orchestration and management of the O-Cloud are important for maximizing resource efficiency and operational agility in the O-RAN. In this regard, the concept of orchestrating and managing the O-Cloud with the SMO has been presented in the related art. In some implementations, the SMO may consist of a Federated O-Cloud Orchestration and Management (FOCOM) entity and a Network Function Orchestration (NFO) entity (may also be referred to as “Network Function Orchestrator”), which operate, manage, and orchestrate O-Cloud and network function (NF) deployment as logical functions, respectively. For instance, the FOCOM may be capable of inventory management and alarm management for O-Cloud, while NFO may be capable of lifecycle management, alarm management, and performance management of NF Deployments on O-Cloud.

The orchestration and management of the O-Cloud may be performed based on a policy. In this regard, a policy may refer to a set of rules, guidelines, or conditions that govern the behavior and actions of cloud resources and services. The policy may be utilized by, for example, the NFO and/or the FOCOM in the SMO, to automate various aspects of cloud management and ensure that the cloud environment operates in accordance with predefined rules and objectives. In view of the above, the policy may be a key enabler for improving the agility of orchestration and management of the O-Cloud, and defining the policy is an important aspect for O-Cloud orchestration and management.

Example embodiments of the present disclosure provide a system, a method, a device, and the like, that facilitate the provisioning of a policy for O-Cloud orchestration and management. Specifically, example embodiments of the present disclosure leverage the non-real-time (Non-RT) radio access network intelligent controller (RIC) to generate various types of policy for orchestrating and managing the O-Cloud (may be referred to as “Non-RT RIC policy” or “O-Cloud policy” herein). Each of the types of the policy contains novel attributes or parameters that satisfy different network requirements, scenarios, and use cases in O-RAN cloud environment.

In this regard, it is contemplated that the example embodiments of the present disclosure may also be implemented by any suitable modules or entities in any suitable systems or apparatus, without departing from the scope of the present disclosure. For instance, although it is described herein that the Non-RT RIC may generate and provide one or more policies for the execution of at least one of the NFO and FOCOM, it can be understood that any other suitable modules or entities in any suitable systems (e.g., O-RAN systems, 3GPP systems, 5G systems, 6G systems, etc.) may generate or create the one or more O-Cloud policies in a similar manner, said one or more O-Cloud policies may be provided or transferred to other suitable modules or entities in any suitable systems for utilization, and the like.

Further, it is contemplated that features, advantages, and significances of example embodiments described hereinabove are merely a portion of the present disclosure, and are not intended to be exhaustive or to limit the scope of the present disclosure. Further descriptions of the features, components, configuration, operation are provided in the following.

### Example System Architecture

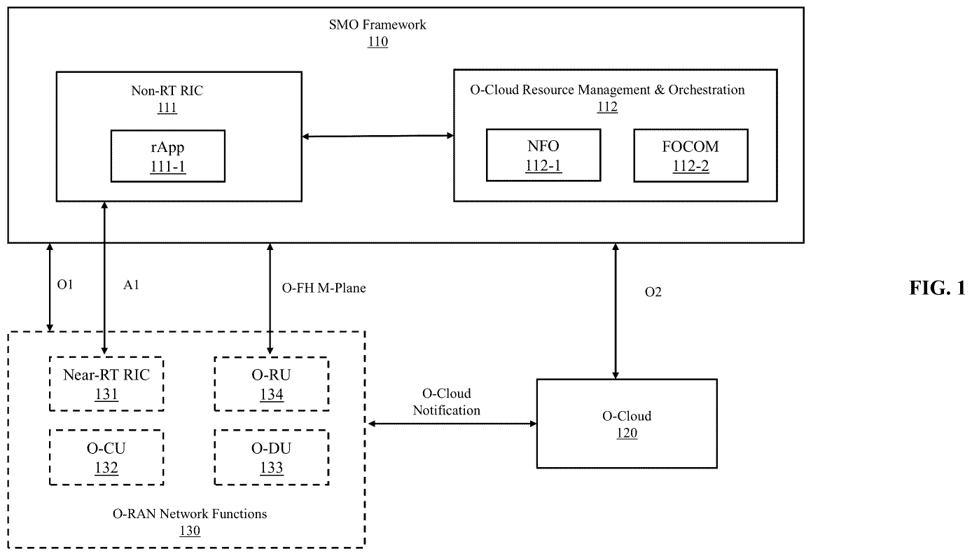

FIG. 1 illustrates an open radio access network (O-RAN) architecture in which one or more example embodiments of the present disclosure may be implemented. As shown in FIG. 1, the system architecture may include at least one service management and orchestration (SMO) framework 110, at least one O-RAN Cloud (O-Cloud) 120, and optionally, a plurality of O-RAN Network Functions 130. It is contemplated that FIG. 1 is merely an example embodiment, and the actual implementations may vary according to requirements, without departing from the scope of the present disclosure. For example, in some example embodiments, the system architecture may further include a service manage and exposure (SME) entity, a policy management and information (PMI) entity, and the like.

As described above, the O-Cloud 120 may refer to a cloud computing platform comprising a collection of physical infrastructure nodes or entities that meet O-RAN requirements to host the relevant O-RAN network entities or network functions (e.g., at least one component of the SMO framework 110, at least one of the plurality of O-RAN Network Functions 130, etc.), the supporting software components (e.g., operating system, virtual machine monitor, container runtime, etc.), and the appropriate management orchestration function. According to example embodiments, the O-Cloud 120 may refer to a single federated cloud that is constituted by multiple O-Clouds (e.g., same type of O-Clouds, a mixture of different types of O-Clouds, etc.) Alternatively or additionally, the O-Cloud 120 may refer to a cloud cluster that consists of a plurality of O-Cloud nodes (e.g., at least one of the O-RAN network function 120, a virtualized network function (VNF), a containerized/cloudified network function (CNF), etc.)

The SMO framework 110 may be configured to orchestrate and manage the O-Cloud 120 and the O-RAN Network Functions 130. As illustrated in FIG. 1, the SMO framework 110 may include at least one non-real-time (Non-RT) RAN intelligent controller (RIC) 111 that may be configured to implement at least one application (rApp) 111-1.

The Non-RT RIC 111 may be a software-defined component that implements modular applications (e.g., rApp 111-1) to facilitate multivendor operability, as well as to automate and optimize RAN operations. In some example implementations, the Non-RT RIC 111 may be deployed in the form of VNF, CNF, and the like. In this case, the operations associated with the Non-RT RIC 111 may be performed by, for example, a processor upon executing the software form Non-RT RIC 111 (or the computer-executable instructions associated therewith).

In some example embodiments, the Non-RT RIC 111 may be the control point of a non-real-time control loop and may operate on a timescale greater than 1 second within the SMO framework 110. On the other hand, the rApp 111-1 may be a modular application that leverages the functionality exposed by the Non-RT RIC 111 and/or the SMO framework 110 to perform RAN optimization and other functions. For instance, the Non-RT RIC 111 may implement the rApp 111-1 to provide services such as policy management, radio resource management, data analytics, and providing enrichment information. In some example implementations, the Non-RT RIC 111 may implement multiple rApps that were developed or provided by the same vendors and/or by different vendors.

Further, the Non-RT RIC 111 (and the rApp 111-1 implemented therein) may be communicatively coupled to the O-Cloud 120 and the O-RAN Network Functions 130 via the respective interface, and provide orchestration and management thereto. According to example embodiments, the Non-RT RIC 111 may be configured to provide (or be configured to implement the rApp 111-1 to provide) Non-RT RIC related services and RAN optimization. Specifically, the Non-RT RIC 111 may provide (implement the rApp 111-1 to provide) policy-based guidance, Artificial Intelligence (AI)/Machine Learning (ML) model training and management, recommending configuration management actions, and enrichment information to at least one of the O-RAN Network Functions 130 (e.g., the Near-RT RIC 131, etc.) In addition, as further described below, the Non-RT RIC 111 may facilitate (or implement the rApp 111-1 to facilitate) the provisioning of a policy for managing and orchestrating the O-Cloud 120.

Referring still to FIG. 1, in addition to the Non-RT RIC 111, the SMO framework 110 may also include at least one O-Cloud Resource Management and Orchestration entity 120, which may be an SMO function or an entity that is configured to provide O-Cloud management, orchestration, and workflow management. The example functionalities that may be supported by the entity 120 are, for example, discovery and administration of O-Cloud resources, scaling of O-Cloud (e.g., scale-in, scale-out, auto-scaling, etc.), O-Cloud resource and capacity management (e.g., creating, deleting, and/or configuring resource deployment, etc.), O-Cloud software management, O-Cloud network function management, O-Cloud energy management, O-Cloud healing, Fault, Configuration, Accounting, Performance, Security (FCAPS) management of O-Cloud, and the like.

As illustrated in FIG. 1, the O-Cloud Resource Management and Orchestration entity 120 may implement a Network Function Orchestration (NFO) 112-1 and a Federated O-Cloud Orchestration and Management (FOCOM) 112-2. In this regard, the operations of the O-Cloud Resource Management and Orchestration entity 120 may be performed by at least one of the NFO 112-1 and the FOCOM 112-2. In some example implementations, the NFO 112-1 and/or the FOCOM 112-2 may be deployed in the software form (e.g., VNF, CNF, etc.), and the operations associated therewith may be performed by, for example, a processor upon execute the software form NFO 112-1 and/or the software form FOCOM 112-2 (or the computer-executable instructions associated therewith).

The NFO 112-1 may be a logical entity or network function that may be configured to manage the O-Cloud deployment life cycle events, open loop operational procedures, and closed loop operational procedures. In some example implementations, the NFO 112-1 may be responsible for the orchestration of the O-Cloud resources, and managing the deployment of the NF that constitute the O-Cloud 120, either using the O2 Deployment Management Services (O2DMS) profile specified by the European Telecommunications Standards Institute (ETSI) (e.g., ETSI Network Function Virtualization (NFV) O2DMS profile) or O2DMS profile specified by the Kubernetes® (K8S) (e.g., K8S O2DMS profile).

On the other hand, the FOCOM 112-2 may be a logical entity or network function that may be configured to manage the distribution of O-Cloud software and provide orchestration for O-Cloud life cycle processes. According to example embodiments, the FOCOM 112-2 may be configured to manage the O-Cloud infrastructure resources and manage the abstracted resources or software deployed in the O-Cloud (e.g., containers, VMs, etc.) For instance, the FOCOM 112-2 may manage the O-Cloud infrastructure data, monitor the O-Cloud infrastructure, facilitate provisioning of the O-Cloud infrastructure, manage O-Cloud infrastructure software, and manage the O-Cloud infrastructure lifecycle.

According to example embodiments, the NFO 112-1 and FOCOM 112-2 may interoperate with each other to provide management and orchestration to the O-Cloud 120. This leverages the synergies between the NFO 112-1 and FOCOM 112-2 to facilitate a level of coordination between them. The interoperation of the NFO 112-1 and FOCOM 112-2 may be useful specifically in automation and orchestration scenarios, where an automated sequence of the NFO 112-1 and FOCOM 112-2 actions needs to be orchestrated in order to fulfill the successful deployment of a VNF/CNF into the right infrastructure resources, respecting the infrastructure requirements from the deployment descriptors of the CNF or VNF.

The Non-RT RIC 111 and the O-Cloud Resource Management and Orchestration entity 112 may be communicatively coupled to each other via any suitable interface (e.g., an A2 interface, etc.) According to example embodiments, the Non-RT RIC 111 (or at least one rApp implemented therein) and the O-Cloud Resource Management and Orchestration entity 112 (or at least one of the NFO 112-1 and the FOCOM 112-2 implemented therein) may be provided by different vendors. Alternatively, the Non-RT RIC 111 (or at least one rApp implemented therein) and the O-Cloud Resource Management and Orchestration entity 112 (or at least one of the NFO 112-1 and the FOCOM 112-2 implemented therein) may be provided by the same vendor.

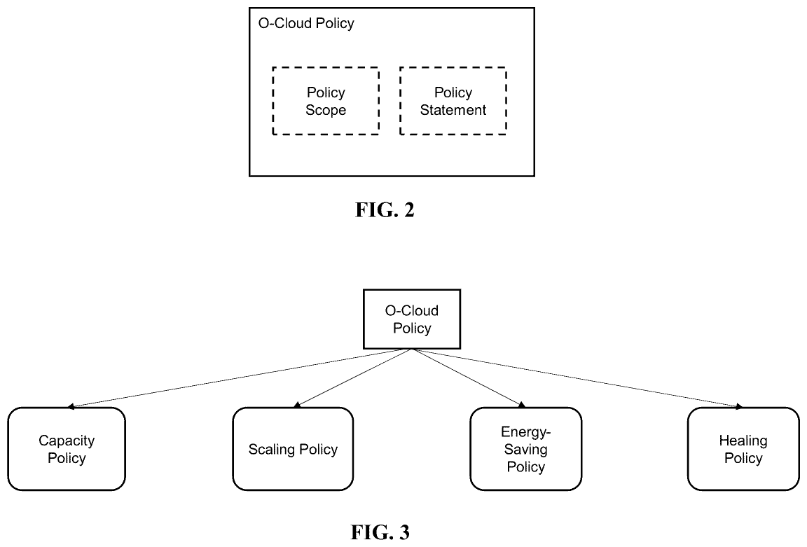

According to example embodiments, the Non-RT RIC 111 may generate and provide a policy associated with the O-Cloud 120 (“O-Cloud policy” herein), and then provide the O-Cloud policy to at least one of the NFO 112-1 and the FOCOM 112-2. The O-Cloud policy is executable by the NFO 112-1 and/or the FOCOM 112-2 to implement one or more operations for managing and orchestrating the O-Cloud 120. In some example embodiments, the Non-RT RIC 111 may provide the O-Cloud policy to both the NFO 112-1 and FOCOM 112-2, and both the NFO 112-1 and FOCOM 112-2 may each perform an operation based on the O-Cloud policy to orchestrate and manage the O-Cloud 120. Further descriptions associated with the O-Cloud policy are provided below with reference to FIG. 2 to FIG. 8.

In view of the above, the Non-RT RIC 111 (and at least one rApp implemented therein) and the O-Cloud Resource Management and Orchestration entity 112 (and at least one of the NFO 112-1 and the FOCOM 112-2 implemented therein) may constitute the SMO framework 110 to facilitate provisioning of an O-Cloud policy and then enforce the O-Cloud policy for O-Cloud orchestration and management.

The SMO framework 110 (and the Non-RT RIC 111 and O-Cloud Resource Management and Orchestration entity 112 implemented therein) may be communicatively coupled to the O-Cloud 120 via an O2 interface. According to example embodiments, the SMO framework 110 may provide platform resources and workload management to the O-Cloud 120 and receive information associated with the O-Cloud 120 therefrom. In addition, the SMO framework 110 may be communicatively coupled to the O-RAN Network Functions 130 (e.g., Near-RT RIC 131, O-CU 132, O-DU 133) via an O1 interface, to thereby provide FCAPS support to said O-RAN Network Functions 130. Further, the SMO framework 110 may be communicatively coupled to the O-RU 134 via an open fronthaul (O-FH) management plane (M-plane) interface, to thereby provide FCAPS support to the O-RU 134. Furthermore, the Non-RT RIC 111 may be communicatively coupled to the Near-RT RIC 131 via the A1 interface for RAN optimization.

Further, as illustrated in FIG. 1, the O-Cloud 120 may be communicatively coupled to the O-RAN Network Functions 130 (e.g., Near-RT RIC 131, O-CU 132, O-DU 133) via an O-Cloud Notification interface to provide O-Cloud related information or notification thereto. For instance, the O-Cloud Notification interface may allow an event consumer (e.g., Near-RT RIC 131, O-CU 132, O-DU 133) to subscribe to and obtain events/status from the O-Cloud 130. In this regard, the SMO framework (or the Non-RT RIC 111 and the O-Cloud Resource Management and Orchestration entity 112 implemented therein) may obtain the information associated with the O-Cloud 120 from the O-RAN Network Functions 130 via the O1 interface, in addition to or in alternative to obtaining said information from the O-Cloud 120 via the O2 interface.

According to example embodiments, the Non-RT RIC 111 (e.g., at least one rApp implemented therein) may interoperate with an SME and/or a PMI to facilitate the provisioning of the O-Cloud policy(s). For instance, the NFO 112-1 and the FOCOM 112-2 may register their respective policy related capabilities to the SME and/or the PMI, and then create and/or register various policy types (e.g., capacity policy, scaling policy, energy-saving policy, healing policy, etc.) with the SME and/or the PMI. In some example embodiments, the Non-RT RIC 111 (e.g., at least one rApp implemented therein) may discover or obtain the information associated with the policy related capabilities of the NFO and/or the FOCOM from the SME and/or the PMI, may discover or obtain the information associated with the policy types supported by the NFO and/or the FOCOM from the SME and/or the PMI, and may utilize these information to create and/or update a policy for the NFO and/or the FOCOM. According to example embodiments, the Non-RT RIC 111 (e.g., at least one rApp implemented therein) may create the policy with SME and/or PMI and the SME and/or PMI may allocate the created policy to the NFO and/or the FOCOM (e.g., based on the scope mentioned in the policy). Further, the Non-RT RIC 111 (e.g., at least one rApp implemented therein) may perform monitoring based on, for example, performance management (PM), fault management (FM), and the like, and then update a policy with the SME/PMI and the SME/PMI may then update the NFO and/or the FOCOM regarding the same.

Referring still to FIG. 1, the O-RAN Network Functions 130 may include a Near-RT RIC 131, an O-CU 132, an O-DU 133, and an O-RU 134. According to example embodiments, the Near-RT RIC 131 may be communicatively coupled to a plurality of O-CUs via an E2 interface, each of the O-CUs may be communicatively coupled to a plurality of O-DUs via an F1 interface and/or the E2 interface, and each of the O-DUs may be communicatively coupled to a plurality of O-RUs via one or more O-FH Control (C), User (U), Synchronization(S), and Management (M) plane interfaces.

The Near-RT RIC 131 may refer to a logical function that enables near-real-time control and optimization of RAN elements and resources. For instance, the Near-RT RIC 131 may provide near-real-time control and optimization via fine-grained (e.g., UE basis, Cell basis, etc.) data collection and actions over the E2 interface. In some example implementations, the Near-RT RIC 131 may operate on a timescale between 10 milliseconds and 1 second and may be coupled with the O-CU 132 and the O-DU 133 via the E2 interface. The Near-RT RIC 131 may use the E2 interface to control the underlying RAN elements (E2 nodes/network functions) over a near-real-time control loop. According to example embodiments, the Near-RT RIC 131 may host or implement an application (xApp) to implement the functions or operations associated with the Near-RT RIC 131.

Next, the descriptions of the O-CU 132, the O-DU 133, and the O-RU 134 are provided. Generally, the O-CU 132, the O-DU 133, and the O-RU 134 may constitute a base station, such as a gNodeB (gNB) of 5G NR, a node in Next Generation Radio Access Network (NG-RAN), a base station of a 6G network, and the like.

According to example embodiments, the O-CU 132 and the O-DU 133 may be defined in software form and may be deployed in one or more network nodes. For instance, the O-CU 132 and the O-DU 133 may be deployed in one or more servers in the form of VNF, CNF, and the like. According to example embodiments, the O-CU 132 and the O-DU 133 may be deployed in the same network node (e.g., same server) and/or may be located at a similar geographical location (e.g., be deployed in different servers in the same data center). According to example embodiments, the O-CU 132 and the O-DU 133 may be deployed in different network nodes and/or may be located at different geographical locations. For instance, the O-CU 132 may be deployed in one or more central servers (i.e., servers in one or more central data centers), and the O-DU 133 may be deployed in one or more edge servers (i.e., servers in one or more edge data centers).

The O-DU 133 may receive radio signals from an end user (via one or more UEs and one or more cells) and may provide operation or support for lower layers of protocol stacks (e.g., RLC layer, MAC layer, Physical Layer, etc.) accordingly. As an example, the O-DU 133 may perform one or more scheduling operations. The O-CU 132 may communicatively couple the O-DU 133 to a core network (e.g., 4G Evolved Packet Core (EPC) network, 5G Core network, etc.) and may receive the radio signals from the O-DU 133, thereby providing operation or support for higher layers of protocol stacks (e.g., PDCP layer, RRC layer, etc.) accordingly.

According to example embodiments, the O-CU 132 may include an O-CU control plane (O-CU-CP) and an O-CU user plane (O-CU-UP). The O-CU-CP may refer to the logical node that hosts or implements the RRC and the control plane part of the PDCP protocol, and may be responsible for managing the signaling between the core network and the radio network, handling tasks such as session management, radio bearer control, and mobility management. On the other hand, the O-CU-UP may refer to the logical node that hosts or implements the user plane part of the PDCP protocol and the SDAP protocol, and may be responsible for managing the data traffic and the transmission of user data packets. The O-CU-CP and the O-CU-UP may be coupled to each other via the E1 interface.

Further, a single O-DU 133 may host or serve multiple network cells formed by multiple O-RUs 134. According to example embodiments, the O-DU 133 may implement various radio technologies, such as massive multiple-input multiple-output (MIMO), beamforming, and the like, to optimize radio communication among the multiple cells and the O-CU 132. In some example implementations, the O-DU 133 may concurrently host or serve hundreds (e.g., 512, etc.) of cells at a time.

The O-RU 134 may be a physical node that converts radio signals from antennas to digital signals that can be transmitted over the Front Haul to the O-DU 133. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which at least one O-RU 134, at least one antenna system, and any other suitable type of transport network element (TNE), may be deployed therein. According to example embodiments, the O-DU 133 may be configured to control or instruct the associated O-RU(s) via one or more of the O-FH C/U/S/M plane interfaces. On the other hand, the capability exchange between the O-DU 133 and the O-RU(s) 134 may be performed via the O-FH M-plane interface.

In view of the above, example embodiments of the present disclosure introduce a system and a mechanism for provisioning one or more policies for orchestrating and managing the O-Cloud in the O-RAN architecture. For instance, the Non-RT RIC 111 may be utilized to generate and provide various types of O-Cloud policies to the NFO 112-1 and/or the FOCOM 112-2. Accordingly, the NFO 112-1 and/or the FOCOM 112-2 may utilize the O-cloud policy(s) provided by the Non-RT RIC 111 to perform an appropriate operation(s) to orchestrate and manage the O-Cloud 120. Further details of the O-Cloud policies are provided in the following.

### Examples of O-Cloud Policy

As described above, the O-Cloud 120 may be orchestrated and managed by, for example, the NFO 112-1 and the FOCOM 112-2, based on at least one policy. Generally, a policy described herein may refer to a set of rules, guidelines, or conditions that govern the behavior and actions of the O-Cloud 120 and the associated cloud resources/services. Policies may be used to automate various aspects of cloud management/orchestration and ensure the that cloud environment operates in accordance with predefined rules and objectives. Policies may typically define how resources are to be provisioned, configured, monitored, and scaled within the cloud environment. Further, policies may help operators maintain control, efficiency, and consistency in cloud operations while aligning with critical requirements and optimal practices. The policies are typically expressed in a structured format that defines a scope, objectives, and/or conditional statements or constraints. In summary, the policies are the key enabler for improving the agility of network orchestration and management.

Example embodiments of the present disclosure facilitate the provisioning of at least one policy for O-Cloud orchestration and management. For descriptive purposes, the policy provided by example embodiments may be referred to as “O-Cloud policy” herein (said policy may also be referred to as “Non-RT RIC policy” or any other suitable terms, without departing from the scope of the present disclosure). In the following, descriptions of several examples of the O-Cloud policy of the example embodiments of the present disclosure are provided.

FIG. 2 illustrates a block diagram of an example O-Cloud policy, according to one or more example embodiments. As illustrated in FIG. 2, the O-Cloud policy includes information associated with a policy scope and a policy statement. The policy scope (may also be referred to as “scope identifier”) may define or specify the specific node or resource to which the policy statement should be applied, and the policy statement may define or specify an operation associated with the policy, such as an objective of the operation (may also be referred to as “policy objective”) and a resource associated with the operation (may also be referred to as “policy resource”). Further, the policy statement may also refer to what the policy shall do on the policy scope defined node(s) or resource(s).

According to example embodiments, the O-Cloud policy may be defined based on the policy structure of the A1 policy (i.e., a policy defined and specified in the technical specifications of the O-RAN Alliance). In this regard, the policy scope of the O-Cloud policy may include a description of a scope identifier, and the policy statement of the O-Cloud policy may include a description of a policy objective and a policy resource. An example of an A1 policy is illustrated in the following Table 1.

TABLE 1
Example A1 Policy

| Content | Example Contents |
|---|---|
| Scope Identifier | { |
| | “Scope”: { |
| | “sliceId”: { |
| | “sst”: 11, |
| | “sd”: “456DEF”, |
| | “plmnId”: { |
| | “mcc”:“248”, |
| | “mnc”:“35” |
| | } |
| | } |
| | }, |
| Policy Objective | “qoeObjectives”: { |
| | “qoeScore”: 4.25 |
| | }, |
| Policy Resources | “tspResources”: [ |
| | { |
| | “cellIdList”: [ |
| | {“plmnId”: {“mcc”: “248”,“mnc”: “35”}, |
| | “cId”: {“ncI”: 55}}, |
| | {“plmnId”: {“mcc”: “248”,“mnc”: “35”}, |
| | “cId”: {“ncI”: 65}} |
| | ], |
| | “preference”: “SHALL” |
| | }, |
| | { |
| | “cellIdList”: [ |
| | {“plmnId”: {“mcc”: “248”,“mnc”: “35”}, |
| | “cId”: {“ncI”: 21}}, |
| | {“plmnId”: {“mcc”: “248”,“mnc”: “35”}, |
| | “cId”: {“ncI”: 22}} |
| | {“plmnId”: {“mcc”: “248”,“mnc”: “35”}, |
| | “cId”: {“ncI”: 23}} |
| | ], |
| | “preference”: “AVOID” |
| | } |
| | ] |
| | } |

The scope identifier may define or specify the specific node(s) or resource(s) to which the policy is applied (or to be applied). In the example of Table 1, the scope identifier specifies a specific network slice to which the A1 policy is applied. In the context of O-Cloud policy, the scope identifier may comprise a parameter associated with an O-Cloud node or cluster, an O-cloud controller (e.g., NFO, FOCOM, etc.), and any other suitable resources or entities to which the O-Cloud policy can be applied. For instance, the scope identifier may include an identifier (ID) and/or the name of the NFO and/or FOCOM that would be executing the policy, an ID/name of an NF to be managed, and the like.

The policy objective may define or specify the objective or goal of the policy. In the example of Table 1, the policy objective is associated with quality of experience (QoE) that defines a goal or objective of user's experiences with a network service (e.g., network speed, network reliability, etc.) In addition to or in alternative to the QoE objective, the policy objective may also include, for example, an energy-saving objective (e.g., energy efficiency objective, energy-consumption objective, etc.), a resource utilization objective (e.g., central processing unit (CPU) utilization objective, memory utilization objective, etc.), a scaling objective, and any other suitable objectives or goals to be achieved for orchestrating and managing the O-Cloud. Each of these types of policy objectives may comprise specific parameters associated therewith (further described with reference to the example policies in below).

The policy resource may define or specify a resource associated with the policy. For instance, the policy resource may include a parameter specifying a condition for resource usage for the policy. In the example of Table 1, the policy resource includes a list of cell IDs to which the policy should be applied (or can be applied) and a list of cell IDs to which the policy should be excluded (or can be avoided). In the context of O-Cloud policy, the policy resource may include various types of parameters or configurations, such as O-Cloud node/clusters preferences (e.g., O-Cloud node(s) to which the policy is applied or can be applied, O-Cloud node(s) that should be avoided from the policy, etc.), measuring conditions for activating objectives, configuration(s) associated with an operation associated with the policy, and the like.

According to example embodiments, in addition to or in alternative to the A1 policy structure, the O-Cloud policy may also be defined based on the policy structure defined and specified in the Open Network Automation Platform (ONAP). An example of an ONAP policy is illustrated in the following Table 2

TABLE 2
Example ONAP Policy

| Content | Example Contents |
|---|---|
| Policy | { |
| Scope | “priority”: “5”, |
| | “riskType”: “test”, |
| | “riskLevel”: “2”, |
| | “guard”: “False”, |
| | “content”: { |
| | “identity”: “minGuarantee_vGMuxInfra”, |
| | “policyScope”: [“vCPE”, “US”, “INTERNATIONAL”, “ip”, |
| | “vGMuxInfra”], |
| | } |
| Policy | { |
| Objective | “minGuaranteeProperty”: { |
| | “cpu”: “true”, |
| | “memory”: “false”, |
| | }, |
| | “type”: “minGuaranteePolicy”, |
| Policy | “resources”: [“vGMuxInfra”], |
| Resource | “applicableResources”: “any” |
| | } |

The example ONAP policy illustrated in above Table 2 is associated with a minimum guarantee policy, the fields or attributes of which may be specified using the Hardware Platform Awareness (HPA) policy model and/or may be generated from a Topology and Orchestration Specification for Cloud Applications (TOSCA) service model specified by the associated vendors or service designers.

According to example embodiments, the O-Cloud policy may be specified or defined by a policy schema. In this regard, the policy schema may define or specify a structured format that outlines the attributes and contents of the O-Cloud policy. For instance, the policy schema may specify the name, descriptions, statements, and data structure of the O-Cloud policy, which may include the types of parameters, the associated values and settings, and the like. In some example implementations, the schema may define the A1-based O-Cloud policy(s) and/or the ONAP-based O-Cloud policy(s). In some example embodiments, the O-Cloud policy(s) may be defined in the format of JavaScript Object Notation (JSON). Further, the policy schema may be managed by the NFO and/or FOCOM, and the Non-RT RIC may obtain (or may implement the rApp to obtain) the schema from the NFO and/or FOCOM when required and then generate the O-Cloud policy(s) based thereon.

According to example embodiments, the Non-RT RIC may generate various types of O-Cloud policies for managing and orchestrating the O-Cloud. For instance, FIG. 3 illustrates a block diagram of various types of O-Cloud policies, according to one or more example embodiments. As illustrated in FIG. 3, the O-Cloud policy may be categorized into: a capacity policy, a scaling policy, an energy-saving policy, a healing policy, and a combination thereof. As further described below, one or more of these policies may be further categorized into different specific types of policies (e.g., a scaling policy may include an NF predictive auto-scaling policy, an energy-saving policy may include a node shutdown policy, etc.) These O-Cloud policies may be generated and provided by the Non-RT RIC, and may be executed by the NFO and/or FOCOM to perform one or more operations for managing and/or orchestrating the O-Cloud. In the following, examples of each of the aforesaid types of O-Cloud policy are described.

### Capacity Policy

This type of O-Cloud policy defines at least one resource management operation associated with the O-Cloud. Specifically, the capacity policy may specify the resource management operation for allocating resources to the O-Cloud, thereby managing the capacity of the O-Cloud. For instance, the capacity policy may be designed and utilized for resource allocation to an NF (or an O-Cloud node and/or cluster that implements the NF) of the O-Cloud based on forecasted demand (e.g., expected traffic load analyzed by the Non-RT RIC, etc.), thereby ensuring that the network function has enough capacity to operate optimally.

According to example embodiments, the capacity policy may be generated by the Non-RT RIC (or the rApp implemented therein) based on, for example, data associated with the O-Cloud (e.g., resource consumption, data volume consumption, etc.) For instance, the Non-RT RIC may continuously (or periodically) collect the O-Cloud data (from the O-Cloud via the O2 interface, from the O-RAN Network Functions via the O1 interface, etc.) and then predict or determine a load or network traffic of the O-Cloud based thereon. Accordingly, based on determining that the currently allocated resources (e.g., CPU, memory, storage, etc.) are insufficient for handling the O-Cloud load/network traffic or may result in the degradation of the O-Cloud performance, the Non-RT RIC may generate the capacity policy (or update an existing capacity policy) based on the predicted/determined requirement and then provide the capacity policy to the NFO/FOCOM for execution.

According to example embodiments, the capacity policy may include a scope identifier. In this regard, the scope identifier may include at least one parameter associated with a controller, such as the NFO or FOCOM, which may execute the capacity policy. For instance, the scope identifier of the capacity policy may include a parameter associated with the NFO and/or the FOCOM, such as: an ID of the NFO and/or the FOCOM, a name/title of the NFO and/or the FOCOM, and the like. It is contemplated that, when any other suitable entity or component is involved, the scope identifier may also include the parameter associated therewith.

The policy objective of the capacity policy may include a capacity objective. This capacity objective may include at least one parameter associated with a target capacity of the O-Cloud. According to example embodiments, the capacity objective may comprise a parameter (e.g., a value, an operator, a unit, etc.) that defines the target allocation of a resource (e.g., the minimum/maximum of CPU, memory, storage, etc.) to an NF associated with the O-Cloud (e.g., an NF of an O-Cloud node or an O-Cloud cluster, etc.) Accordingly, the capacity objective may define a condition for triggering the resource management operation. For instance, whenever the NFO/FOCOM determines that target resource allocation is violated (e.g., the allocation of the CPU to a specific NF is below the minimum allocation CPU unit defined in the policy objective, etc.), the NFO/FOCOM may trigger the execution of the resource management operation (e.g., allocating additional resources, reducing the allocated resources, etc.)

The policy resource of the capacity policy may include a capacity resource. In this regard, the capacity resource may include at least one parameter associated with a target O-Cloud node and/or a target O-Cloud cluster (or a list of target O-Cloud nodes and/or a list of target O-Cloud clusters) to which the resource management operation is applicable (or should be applied). For instance, the policy resource may include an ID of the target O-Cloud node/target cluster, a configuration for performing the resource management operation on the target O-Cloud node/cluster, a preference attribute (e.g., “SHALL”, “PREFER”, etc.) that indicates the nature of the target node(s)/cluster(s), and the like.

Additionally or alternatively, the capacity resource may include a parameter associated with an O-Cloud node and/or an O-Cloud cluster (or a list of O-Cloud nodes and/or a list of O-Cloud clusters) which can be excluded (or should be excluded) from the resource management operation. For instance, the policy resource may include an ID of the O-Cloud node(s)/cluster(s) that can be (or should be) avoided from the resource management operation, a preference attribute (e.g., “AVOID”, “FORBID”, etc.) that indicates the nature of said O-Cloud node(s)/cluster(s), and the like.

An example of a capacity policy presented in the following Table 3.

TABLE 3
Example Capacity Policy

```
# Capacity Policy
{
  ″policy_id″: “1″,
  “Scope”: {
  ″Controller″ : ″FOCOM“
},
“capacityObjectives” : {
          ″cpu″: {″value″: 2, ″operator″: ″>″},
          ″memory″: {″value″: 4, ″operator″: ″>″, ″unit″: ″GB″}
          ″storage″: {″value″: 80, ″operator″: ″>″, ″unit″: ″GB″}
  “capacityResources”: [
{
  “o-cloudIdList “ [
        {“o-cloudID″: {“ABX89C″}},
        {“o-cloudID″: {“ABX89C″}}
      ],
      ″preference″: ″SHALL″
},
{
  “o-cloudIdList “ [
        {“o-cloudID″: {“ZBX89C″}},
        {“o-cloudID″: {“ZBX89C″}}
    ],
    ″preference″: “AVOID″
    }
  ]
}
```

In the example of Table 3, the scope identifier of the capacity policy includes information of the controller (i.e., FOCOM) that can apply or execute the capacity policy. Further, the capacity objective includes a combination of a value and an operator that defines the minimum allocation of the CPU (e.g., “minimum allocation of 2 CPUs”), a combination of a value, an operator, and an unit that defines the minimum allocation of the memory (e.g., “minimum allocation of 4 GB memory”), and a combination of a value, an operator, and unit that defines the minimum allocation of the storage (e.g., “minimum allocation of 80 GB storage”). Furthermore, the capacity resources include an inclusion list that specifies the O-Cloud nodes to which the resource management operation shall be applied (whenever one or more of the minimum allocations specified in the capacity objective is violated) and an exclusion list that specifies the O-Cloud nodes which can be avoided from the resource management operation.

According to the example of above Table 3, once the capacity policy is generated by the Non-RT RIC, said capacity policy may be provided by the Non-RT RIC to the FOCOM. In this regard, the capacity policy may be generated by the Non-RT RIC based on, for example, a forecasted or detected traffic load. Accordingly, the FOCOM may execute or enforce the capacity policy to perform appropriate resource management operations based on the capacity policy to orchestrate or manage (e.g., to adjust or allocate the resources based on the capacity policy, etc.) the O-Cloud nodes specified in the inclusion list.

In view of the above, the Non-RT RIC may generate or update a capacity policy based on, for example, the demand or requirement (e.g., load balancing, quality assurance, etc.) detected or predicted based on real-time (or near-real-time) O-Cloud data. Accordingly, the capacity policy may be executed by a controller (e.g., NFO, FOCOM, etc.) for orchestrating and managing the resource allocation of the O-Cloud. Accordingly, the capacity of the O-Cloud can be automatically and dynamically managed and maintained at the optimal level. To this end, by provisioning the capacity policy, example embodiments of the present disclosure may enable automated decision-making in various stages of O-Cloud orchestration and management.

### Scaling Policy

This type of O-Cloud policy defines at least one scaling operation associated with the O-Cloud. Specifically, the scaling policy may specify the scaling operation for managing the entities (e.g., an NF, an O-Cloud node, etc.) associated with the O-Cloud. For instance, the scaling operation may include a scale-out operation that adds more entities (e.g., nodes, virtual machines, containers, NF instances, etc.) to the O-Cloud to handle the increased load (e.g., by spreading the load across the increased entities). Additionally or alternatively, the scaling operation may include a scale-in operation that reduces the number of O-Cloud entities when, for example, the load or demand of the O-Cloud is low, thereby optimizing the resource usage. According to example embodiments, the scaling operations allow the controller or orchestrator (e.g., the NFO, the FOCOM, etc.) to increase/decrease the footprint of an NF of the O-Cloud by increasing/decreasing the instance(s) of the NF. Further, in some implementations, the Non-RT RIC may provide (or implement the rApp to provide) the scaling policy in terms of auto-scaling policy group(s).

According to example embodiments, the scaling policy may include an NF predictive auto-scaling policy which, when being executed by the NFO and/or the FOCOM, enables the NFO and/or the FOCOM to automatically perform at least one scaling operation on at least one NF of the O-Cloud. In this regard, the NF predictive auto-scaling policy may be generated by the Non-RT RIC (or the rApp implemented therein) based on, for example, data associated with the O-Cloud (e.g., resource consumption, data volume consumption, etc.) For instance, the Non-RT RIC may continuously (or periodically) collect the O-Cloud data (from the O-Cloud via the O2 interface, from the O-RAN Network Functions via the O1 interface, etc.) and then predict or determine a load or network traffic of the O-Cloud based thereon. Accordingly, based on determining that the currently allocated resources (e.g., instances/containers of network function, etc.) are insufficient for handling the O-Cloud load/network traffic or may result in the degradation of the O-Cloud performance, the Non-RT RIC may generate the scaling policy (or update an existing scaling policy) based on the predicted/determined demand and then provide the scaling policy to the NFO/FOCOM for execution.

Additionally or alternatively, the scaling policy may include an NF scheduled auto-scaling policy which, when being executed by the NFO and/or the FOCOM, enables the NFO and/or the FOCOM to automatically perform at least one scaling operation on at least one NF of the O-Cloud. In this regard, the NF scheduled auto-scaling policy may be generated by the Non-RT RIC (or the rApp implemented therein) based on, for example, a schedule for executing the policy that may be predefined by a user (e.g., a network operator, etc.) For instance, the Non-RT RIC may generate the scaling policy (or update an existing scaling policy) according to the schedule, and then provide the scaling policy to the NFO/FOCOM for execution.

According to example embodiments, the scaling policy may include a scope identifier. In this regard, the scope identifier may include at least one parameter associated with a controller, such as the NFO or FOCOM, which may execute the scaling policy. For instance, the scope identifier of the scaling policy may include a parameter associated with the NFO and/or the FOCOM, such as: an ID of the NFO and/or the FOCOM, a name/title of the NFO and/or the FOCOM, and the like. It is contemplated that, when any other suitable entity or component is involved, the scope identifier may also include the parameter associated therewith.

The policy objective of the scaling policy may include a scaling objective. This scaling objective may include at least one parameter associated with a target scale of the O-Cloud. In this regard, the target scale may be defined in terms of resource utilization (e.g., a scale that may achieve a desired level of resource utilization, etc.), in terms of the size of a scaling group that consists of at least one NF instance (e.g., a scale which may achieve a desired size of the scaling group), and the combination thereof.

According to example embodiments, the scaling objective may comprise at least one of the following parameters: a parameter that defines whether or not the scaling operation is enabled (e.g., a state description such as “Enable” or “Disable”, a Boolean value such as “True” and “False”, etc.) when one or more of the scaling objectives are violated, a parameter (e.g., a value, a unit, etc.) that defines a condition for executing and/or terminating the scaling operation (e.g., maximum/minimum utilization of a resource such as CPU and memory, maximum/minimum/desired size of an auto-scaling group, etc.), and the like.

The policy resource of the scaling policy may include a scaling resource. In this regard, the scaling resource may include at least one parameter associated with the scaling operation, such as at least one of: a timing configuration (e.g., a start time for executing the scaling policy, an end time for terminating the execution of the scaling policy, a cool down period after terminating the execution of the scaling policy, etc.), a scaling configuration (e.g., step size for increasing and/or decreasing an instance of a NF of the O-Cloud, a maximum step size for increasing/decreasing the instance of the NF, etc.), and the like. The timing configuration may be specified by the Non-RT RIC (based on the predicted load and demand of the O-Cloud, etc.) and/or by the user (e.g., network operator), thereby enabling the auto-scaling during the specified period.

In the following, an example for each of the NF predictive auto-scaling policy and NF scheduled auto-scaling policy is provided. Referring first to the following Table 4, which presents an example NF predictive auto-scaling policy.

TABLE 4
Example NF Auto-Scaling Policy

```
  # Scaling Policy
{
  ″policy_id″: “1″,
  “Scope”: {
  ″Controller″ : “NFO″
},
“scalingObjectives” : {
    “scaling =“Enable”
    “maxcpuutilization” =“70”
    “mincpuutilization” =“20”
  “scalingResources”: [
{
    ″StepSize″: ″1″,
    ″MaxSize″: ″4″,
    ″Cooldown″: ″300″
    “StartTime″: ″2023-07-11 18:34:31″,
    ″EndTime″: ″2023-08-11 18:34:53″,
  }
  ]
}
```

In the example of Table 4, the scope identifier of the NF auto-scaling policy includes information of the controller (i.e., NFO) that can apply or execute the scaling policy. Further, the scaling objective includes a parameter that defines that the scaling operation should be enabled (e.g., a state description “Enable”) when one or more of the scaling objectives are violated, and two parameters defining the conditions for executing and terminating the scaling operation (e.g., a maximum CPU utilization that initiates the scaling operation and a minimum CPU utilization that initiates the scaling operation). Further, the scaling resources of the scaling policy include a step size for increasing and/or decreasing an instance of a NF, a maximum step size defining the maximum instances that can be increased and/or decreased per step, a cool down period after terminating the execution of the scaling policy, a start time for initiating the enforcement or execution of the scaling policy, and an end time for terminating the enforcement or execution of the scaling policy.

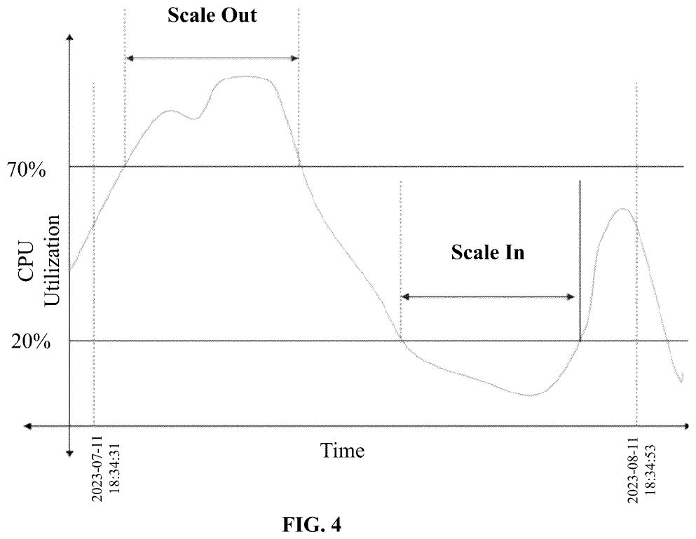

FIG. 4 illustrates a graph of an example use case in which an NF predictive auto-scaling policy is involved in a scaling operation, according to one or more example embodiments. In this example use case, the example scaling policy in above Table 4 is generated by the Non-RT RIC (based on predicted traffic of the O-Cloud and the associated CPU load, etc.) Upon generating the policy, the Non-RT RIC may provide the policy to the target controller (which, in this example use case, is the NFO) for execution. According to example embodiments, the Non-RT RIC may be configured to implement at least one rApp to generate and provide the policy. Accordingly, the target controller (e.g., the NFO) may execute the policy to perform the scaling operation for the O-Cloud according to the configurations defined in the policy.

Referring to FIG. 4, at the time “18:34:31” of “2023 Jul. 11” (i.e., the start time specified in the scaling policy), the NFO may execute the policy to monitor the CPU utilization of the O-Cloud (e.g., CPU utilization of a specific network function, a specific O-Cloud node, a specific O-Cloud cluster, etc.) to determine whether or not the CPU utilization of the O-Cloud satisfies the conditions defined by the scaling objective (i.e., lower/equal to 70% and higher/equal to 20%), until after the time “18:34:53” of “2023 Aug. 11” (i.e., the end time specified in the scaling policy).

As illustrated in FIG. 4, during the period between the start time and end time specified in the policy, when the NFO detects or determines that the CPU utilization is greater than 70% (i.e., violating the maximum CPU utilization specified in the scaling objective), the NFO may perform the scale-out operation by, for example, instantiating additional instance(s) in the step of 1 instance (i.e., as specified by the step size defined in the scaling resources) until the CPU utilization drops below or equal to 70%. According to the policy, the NFO shall increase the instance(s) in the step of 1, until a maximum of 4 additional instances are increased (i.e., as specified by the maximum step size defined in the scaling resources). Similarly, during said period between the start time and end time, when the NFO detects or determines that the CPU utilization is below 20% (i.e., violating the minimum CPU utilization specified in the scaling objective), the NFO may perform the scale-in operation by, for example, removing the instance(s) in the step of 1 instance (i.e., as specified by the step size defined in the scaling resource) until the CPU utilization raises above or equal to 20%.

Referring next to the following Table 5, which presents an example NF scheduled auto-scaling policy.

TABLE 5
Example NF Scheduled Auto-Scaling Policy

```
  # Scaling Policy
{
  ″policy_id″: “1″,
  “Scope”: {
  ″Controller″ : “NFO″
  },
“scalingObjectives” : {
    “scaling =“Enable”
    ″MinSize″: 1,
    ″MaxSize″: 4,
    ″DesiredCapacity″: 2
  }
  “scalingResources”: [
{
  ″Cooldown″ : “300″
  ″ StartTime″: ″2023-07-11 18:34:31.268″,
  ″EndTime″: ″2023-08-11 18:34:53″,
    }
  ]
  }
```

Similar to the example policy in Table 4, the scope identifier of the example policy in Table 5 also includes information of the target controller (i.e., NFO) which can enforce or execute the policy. Further, the scaling objectives of the example policy in Table 5 also include a parameter that defines that the scaling operation should be enabled when one or more of the scaling objectives are violated, and parameters defining the condition for executing and terminating the scaling operation (e.g., a minimum size of an auto-scaling group, a maximum size of the auto-scaling group, a desired size/capacity of the auto-scaling group, etc.) Similarly, the scaling resources of the example policy in Table 5 also include a start time for enforcing or executing the policy, an end time for terminating the enforcement or execution of the policy, and a cool down time/period after terminating the execution of the policy. The timing configuration in the scaling resources may be specified by the Non-RT RIC (based on the predicted load or demand of the O-Cloud, etc.) and/or by the user (e.g., network operator), thereby enabling auto-scaling of the O-Cloud during the specified time period.

The example policy in Table 5 is different from the one in Table 4 in that, the scaling objective of the example policy in Table 5 includes a minimum size of an auto-scaling group, a maximum size of an auto-scaling group, and a desired capacity/size of an auto-scaling group, instead of information defining the utilization of the resources. In addition, the scaling resources of the example policy of Table 5 also do not include information of the step size and maximum step size as in the example policy of Table 4. In this regard, the minimum size of the auto-scaling group may refer to the minimum number of instances to be maintained within the auto-scaling group, the maximum size of the auto-scaling group may refer to the maximum number of instances that can be instantiated within the auto-scaling group, and the desired capacity may refer to a default or optimal configuration that can be (or is desired to be) maintained over a given period. It is contemplated that the aforesaid minimum size, maximum size, and/or desired capacity of the auto-scaling group in the scaling policy may be appropriately configured or adjusted by the user (e.g., network operator) as per requirement.

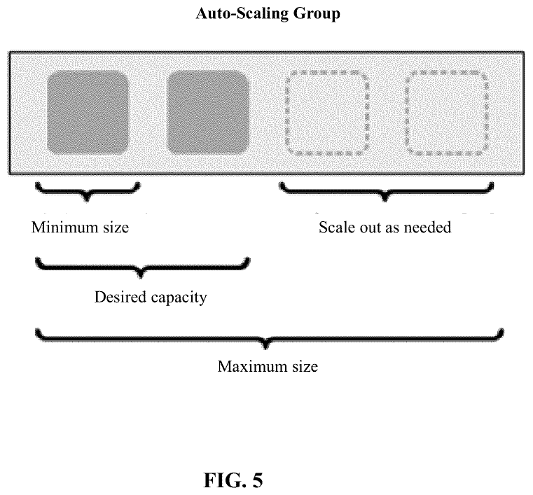

FIG. 5 illustrates a block diagram of an example auto-scaling group defined by a scaling policy, according to one or more embodiments. Generally, an auto-scaling group described herein may refer to a collection of instances that may be treated as a logical grouping for the purposes of auto-scaling and management. In the example of FIG. 5, the example auto-scaling group is defined by the scaling policy in Table 5, which has a maximum size of 4 instances, a minimum size of 1 instance, and a desired capacity/size of 2 instances. In this example, during the period specified by the scaling policy (i.e., from “18:34:31” of “2023 Jul. 11” to “18:34:53” of “2023 Aug. 11”), the NFO may monitor the auto-scaling group and then perform scaling operation when required. For instance, when the NFO determines that the auto-scaling group has more than 2 instances (the number of which is greater than the desired capacity defined in the scaling policy), the NFO may be configured to perform (or may implement the rApp to perform) the scaling operation such that the size of the auto-scaling group can be maintained below the maximum size of 4 instances and be kept to (or close to) the desired size of 2 instances. Similarly, when the NFO determines that the auto-scaling group has less than 2 instances (the number of which is less than the desired capacity defined in the scaling policy), the NFO may be configured to perform (or may implement the rApp to perform) the scaling operation such that the size of the auto-scaling group can be maintained above the minimum size of 1 instance and be kept to (or close to) the desired capacity of 2 instances.

According to embodiments, the Non-RT RIC may generate (or implement the rApp to generate) a scaling policy that includes one or more configurations/parameters of the above-described NF predictive auto-scaling policy and one or more configurations/parameters of the above-described NF scheduled auto-scaling policy.

In view of the above, example embodiments of the present disclosure leverage the Non-RT RIC to facilitate the provisioning of the scaling policy, and said scaling policy may be executable by a controller (e.g., NFO, FOCOM, etc.) associated with the O-Cloud to automatically and dynamically manage the scaling of the O-Cloud. For instance, the O-Cloud may be scaled-in and/or scaled-out based on the scaling policy, which is generated/updated by the Non-RT RIC according to the actual demand or requirement predicted based on real-time (or near-real-time) O-Cloud data. In addition, the O-Cloud may also be automatically scaled-in and/or scaled-out based on the user's desired configuration, such as the user's desired size of the auto-scaling group, the user's desired policy enforcement period, and the like.

To this end, example embodiments of the present disclosure may enable cloud automation by dynamic adjustments in real-time (or near-real-time) based on changing conditions or events in the O-Cloud, thereby allowing the network operator to optimize resource allocation, ensuring network performance, and managing the associated costs effectively.

### Energy-Saving Policy

This type of O-Cloud policy defines at least one energy-saving operation associated with the O-Cloud. Specifically, the energy-saving policy may specify the energy-saving operation for conserving the energy consumption of the O-Cloud and optimizing the energy efficiency thereof. As a non-limiting example, the energy-saving policy may contain condition(s) and configuration(s) for shutting down an O-Cloud node, instructing the O-Cloud node to enter an energy-saving mode (e.g., a low power consumption mode, a sleep mode, etc.), and the like.

According to example embodiments, the Non-RT RIC (or the rApp implemented therein) may be configured to continuously (or periodically) collect data associated with the O-Cloud (e.g., RAN mobility, O-Cloud traffic, O-Cloud resource utilization, O-Cloud capacity, etc.), and then predict or determine a load or network traffic of the O-Cloud based thereon. Further, the Non-RT RIC (or the rApp implemented therein) may compare the predicted load/traffic with the future energy consumption of one or more O-Cloud nodes (based on the predicted operational mode of the O-Cloud node(s), etc.), thereby determining whether any of the O-Cloud nodes can be shut down for energy-saving. Accordingly, based on determining at least one O-Cloud node can be shut down for energy-saving, the Non-RT RIC (or the rApp implemented therein) may generate the energy-saving policy and then provide the energy-saving policy to the controller (e.g., NFO, FOCOM, etc.) for execution.

According to example embodiments, the energy-saving policy may include a scope identifier. The scope identifier may include at least one parameter associated with a controller, such as the NFO or FOCOM, which may execute the energy-saving policy. For instance, the scope identifier of the energy-saving policy may include a parameter associated with the NFO and/or the FOCOM, such as: an ID of the NFO and/or the FOCOM, a name/title of the NFO and/or the FOCOM, and the like. It is contemplated that, when any other suitable entity or component is involved, the scope identifier may also include the parameter associated therewith

According to example embodiments, the policy objective of the energy-saving policy may include an energy-saving objective. This energy-saving objective may include at least one parameter associated with the energy-saving operation. According to example embodiments, the energy-saving objective may include at least one of: a parameter defining whether or not the energy-saving operation is enabled (e.g., a state description such as “Enable”/“Disable” or “Y”/“N”, a Boolean value such as “True”/“False”, etc.) when one or more conditions defined in the energy-saving objective are violated, a parameter (e.g., a value, a unit, etc.) that defines a condition for executing and/or terminating the energy-saving operation (e.g., a maximum/minimum utilization of a resource such as CPU and memory, a maximum/minimum performance of the O-Cloud node such as disk throughput, etc.), and a parameter defining a duration of the execution of the energy-saving operation (e.g., a value defining a duration in which the O-Cloud node is required to shut down, etc.) It is contemplated that, in some example implementations, the energy-saving objective may further include a parameter associated with the energy efficiency of the O-Cloud node, a parameter associated with the energy consumption of the O-Cloud node, and the like.

According to example embodiments, the policy resource of the energy-saving policy may include an energy-saving resource. In this regard, the energy-saving resource may include at least one parameter associated with a target O-Cloud node and/or a target O-Cloud cluster (or a list of target O-Cloud nodes and/or a list of target O-Cloud clusters) to which the energy-saving operation can be applied (or should be applied). For instance, the energy-saving resource may include an ID of the target O-Cloud node/target cluster, a configuration for performing the energy-saving operation on the target O-Cloud node/cluster, a preference attribute (e.g., “SHALL”, “PREFER”, etc.) that indicates the nature of the target node(s)/cluster(s), and the like.

Additionally or alternatively, the energy-saving resource may include a parameter associated with an O-Cloud node and/or an O-Cloud cluster (or a list of O-Cloud nodes and/or a list of O-Cloud clusters) which can be excluded (or should be excluded) from the energy-saving operation. For instance, the energy-saving resource may include an ID of the O-Cloud node(s)/cluster(s) that can be (or should be) avoided from the energy-saving operation, a preference attribute (e.g., “AVOID”, “FORBID”, etc.) that indicates the nature of said O-Cloud node(s)/cluster(s), and the like.

Referring next to the following Table 7, which presents an example energy-saving policy.

TABLE 7
Example Energy-Saving Policy

```
# Energy Saving Policy
{
  ″policy_id″: “1″,
  “Scope”: {
  ″Controller″ : “FOCOM″
},
    “esObjectives” : {
          “GracefulNodeShutdown” : Y
          “CPU usage” : {″value″ : 5, ″operator″: “<″},
          “memory usage” : {″value″: 5, ″operator″: “<″},
          “disk throughput” : {″value″: 5, ″operator″: “<″},
          “Tshutdown” : “60min”.
  “esResources”: [
{
  “o-cloudIdList “ [
        {“o-cloudID″: {“ABX89C″}},
        {“o-cloudID″: {“ABX89D″}}
        ],
      ″preference″: ″SHALL″
},
{
  “o-cloudIdList “ [
        {“o-cloudID″: {“ZBX89C″}},
        {“o-cloudID″: {“ZBX89D″}}
      ],
      ″preference″: “AVOID″
    }
  ]
}
```

Similar to the example policies in Tables 4-6, the scope identifier of the example policy in Table 7 also includes information of the target controller (i.e., the name “NFO”) which can enforce or execute the policy. Further, the energy resources of the example policy in Table 7 also include an inclusion list that includes the ID of the O-Cloud nodes to which the energy-saving operation shall be (or can be) applied (whenever one or more of the minimum allocations specified in the energy-saving objective is violated) and an exclusion list that specifies the O-Cloud nodes which can be (or shall be) avoided from the energy-saving operation.

Further, the energy-saving objectives of the example policy in Table 7 includes a state description “Y” (i.e., “YES”) that defines that a graceful node shutdown operation (i.e., an energy-saving operation) should be executed when one or more conditions defined in the energy-saving objectives are violated, and parameters (i.e., a minimum CPU usage, a minimum memory usage, and a minimum disk throughput) each of which defines a condition or threshold for executing and/or terminating the energy-saving operation. Furthermore, the energy-saving objective in the example policy of Table 7 also includes a value of shutdown time (i.e., 60 minutes), which defines the duration in which the O-Cloud node(s) should stay when the graceful node shutdown operation is performed thereto. In this regard, the parameter(s) of the energy-saving objective may be configured or specified by the user (e.g., network operator) as per requirement.

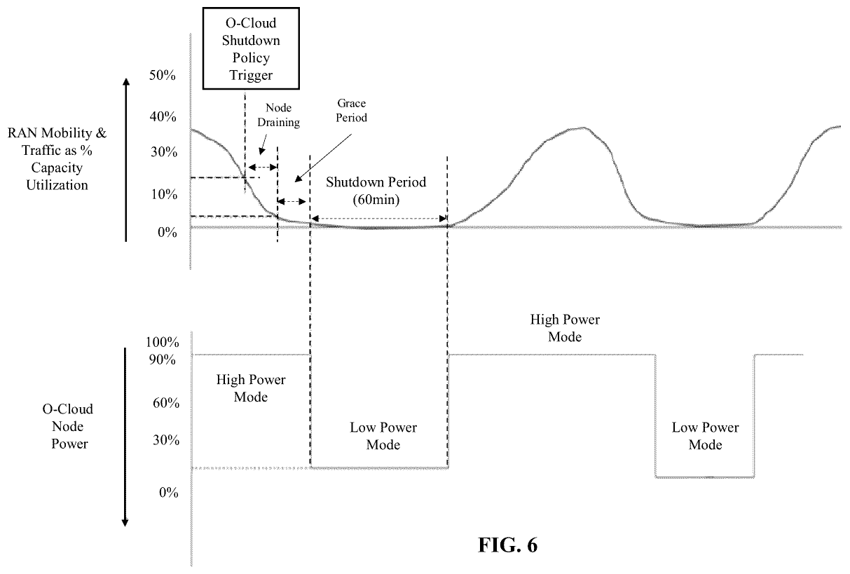

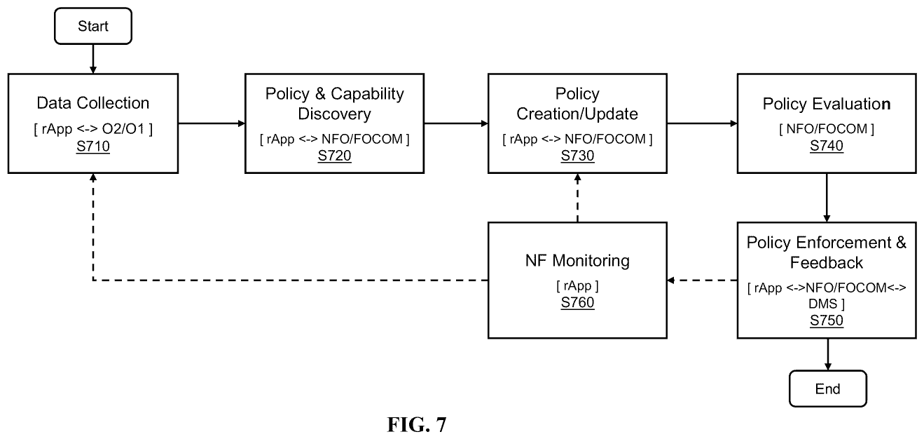

FIG. 6 illustrates graphs of an example use case in which an energy-saving policy is involved in an energy-saving operation, according to one or more example embodiments. In this example use case, the example energy-saving policy in above Table 7 may be generated by the Non-RT RIC (or by the rApp implemented therein) based on, for example, the network condition of the O-Cloud (e.g., RAN mobility, network traffic, etc.), capacity or resource utilization of an O-Cloud node (e.g., CPU utilization, memory utilization, disk usage or throughput, etc.), and the like. Upon generating the policy, the Non-RT RIC may provide the policy to the target controller (which, in this example use case, is the FOCOM) for execution. According to example embodiments, the Non-RT RIC may be configured to implement at least one rApp to generate and provide the policy. Accordingly, the target controller (e.g., the FOCOM) may execute the policy to trigger or perform the energy-saving operation for the O-Cloud according to the configurations defined in the policy.

Referring to FIG. 6, the upper graph illustrates the RAN mobility and traffic of one of the O-Cloud nodes defined in the inclusion list of the policy's energy-saving resource, while the lower graph illustrates the power consumption of said O-Cloud node. Generally, upon receiving the energy-saving policy from the Non-RT RIC (or the rApp implemented therein), the controller (e.g., FOCOM) may identify which O-Cloud node(s) is specified in the inclusion list of the energy-saving resource, and then start monitoring the parameter(s) of the O-Cloud node(s) as specified in the energy-saving objective. Additionally, the controller may concurrently monitor the power consumption of the target O-Cloud node(s) to determine an operational mode (e.g., high power mode, low power mode, etc.) of the target O-Cloud node(s). Accordingly, once the controller determines that at least one condition defined in the energy-saving objective is violated (or will be violated), and the associated target O-Cloud node(s) are in high power mode, the controller may execute the energy-saving operation on the associated target O-Cloud node(s), according to the configuration defined in the energy-saving policy.

In the example use case of FIG. 6, the controller (i.e., the FOCOM) determines “ABX89C” and “ABX89D” as the target O-Cloud nodes, and the “CPU usage”, “memory usage” and “disk throughput” as the target parameters that may each (or in combination) define one or more conditions for triggering the graceful node shutdown (i.e., the energy-saving operation defined in the energy-saving objective of the policy). Accordingly, the controller may monitor the network conditions (e.g., RAN mobility, traffic, etc.) of the target O-Cloud nodes, and then determine the target parameters (e.g., CPU usage, memory usage, disk throughput, etc.) based thereon. In this regard, whenever the controller determines that a condition(s) for triggering the graceful node shutdown on a target O-Cloud node is satisfied (e.g., the CPU usage, memory usage, and/or disk throughput of the target O-Cloud node is smaller than 5%), the controller may determine the operational node of the target O-Cloud node to determine whether or not it can be shut down or be instructed to enter a lower power consumption mode. Based on determining that the target O-Cloud node can be shut down or be instructed to enter the lower power consumption mode, the controller may then execute the associated energy-saving operation on the target O-Cloud node.

In the example use case of FIG. 6, the FOCOM may trigger the graceful node shutdown to the applicable O-Cloud node(s) when the capacity utilization (e.g., defined by the resources utilization based on the RAN mobility and traffic) reaches at least one condition defined in the energy-saving objective while operating at the high power consumption mode. In this regard, the graceful node shutdown is an operation that ensures that the target O-Cloud node turns off (or enters low power consumption mode) without affecting or disrupting ongoing network operation. Upon execution of the graceful node shutdown, the node draining process may be first initiated to safely remove or terminate the resources of the target O-Cloud node (e.g., pods, etc.) and prevent new tasks from starting on the target O-Cloud node, thereby allowing all on-going tasks in the target O-Cloud node to complete before the target O-Cloud node is shut down. The grace period is the amount of time provided to the target O-Cloud node to allow it to finish the ongoing tasks before it is shut down (or entered low power consumption mode). During this period, the target O-Cloud node will not accept any new tasks but will continue to run existing ones until they are completed or the grace period is expired. For example, the default grace defaults to a grace period of 30 seconds, although it is contemplated that the grace period can be appropriately configured by the user (e.g., network operator) as per requirement.

After the grace period is over, the controller may shut down the target O-Cloud node according to the shutdown period (e.g., 60 minutes) defined in the energy-saving objective. During this shutdown period, the target O-Cloud node may enter a standby mode where only essential functions (e.g., powering the system's firmware, remote management services, system health checks and update, etc.) remain powered to enable quick recovery and maintenance tasks.

The example use case of FIG. 6 illustrates a node-level control, in which the energy-saving operation is applied to a target O-Cloud node. In some example embodiments, the controller may perform a network-level or cluster-level control, in which the energy-saving operation is applied to multiple target O-Cloud nodes (or an O-Cloud cluster).

In view of the above, example embodiments of the present disclosure leverage the Non-RT RIC to facilitate the provisioning of the energy-saving policy, and said energy-saving policy may be executable by a controller (e.g., NFO, FOCOM, etc.) associated with the O-Cloud to automatically and dynamically manage the energy consumption and efficiency of the O-Cloud.

For instance, the Non-RT RIC may specify, in the energy-saving policy, one or more energy-saving objectives defining one or more conditions (e.g., when CPU/memory/disk utilization is below a certain level, etc.) to perform one or more energy-saving operations. Further, the Non-RT RIC may specify, in the energy-saving policy, a specific node(s) of the O-Cloud which represents specific area that can be (or should be) targeted for energy savings. Similarly, the Non-RT RIC may also specify, in the energy-saving policy, a specific node(s) of the O-Cloud that can be (or should be) avoided from the energy-saving operation (e.g., node shutdown, etc.) due to, for example, importance of a specific area in terms of capacity, serving priority area, and the like. Accordingly, the controller may execute the energy-saving policy and trigger appropriate energy-saving operation(s) on the associated O-Cloud node(s). To this end, example embodiments of the present disclosure may enable automated energy management of the O-Cloud, thereby optimizing the energy efficiency of the O-Cloud while satisfying the network and user requirements.

### Healing Policy

This type of O-Cloud policy defines at least one healing operation associated with the O-Cloud, such as restarting a failed NF instance, recovering from a backup, redistributing workloads to ensure high availability and resilience, and the like. Specifically, the healing policy may specify the healing operation for automatically detecting and remediating issues or failures in the O-Cloud environment, ensuring the network's resilience and maintaining the quality of services.

According to example embodiments, the Non-RT RIC (or the rApp implemented therein) may be configured to continuously (or periodically) collect data associated with the O-Cloud (e.g., performance metrics, resource utilization, network traffic patterns, error/event logs, etc.) from the O-Cloud (via the O2 interface) and/or from the RAN network function(s) (via the O1 interface), and then assess whether or not any healing operation should be performed. By way of examples, the Non-RT RIC may monitor the performance metrics (e.g., signal strength, latency, etc.) of the O-Cloud to determine whether or not any node or a set of nodes are underperforming, may monitor the resource (e.g., CPU, memory, storage, etc.) utilization to determine whether or not any potential issues or inefficiencies may occur, may analyze the event/error log to identify any recurring issues or faults which need corrective action, and the like.

Accordingly, based on determining that a healing operation is required, the Non-RT RIC (or the rApp implemented therein) may generate the healing policy and then provide the healing policy to the controller (e.g., NFO, FOCOM, etc.) for execution. The healing policy may define the rule(s) and condition(s) for triggering the associated healing operation(s), such as recovering from backups, redistributing workloads, and the like.

According to example embodiments, the healing policy may include a scope identifier. The scope identifier may include at least one parameter associated with a controller, such as the NFO and/or FOCOM, which may execute the healing policy. For instance, the scope identifier of the healing policy may include a parameter associated with the NFO and/or the FOCOM, such as: an ID of the NFO and/or the FOCOM, a name/title of the NFO and/or the FOCOM, and the like. Further, the scope identifier may include at least one parameter associated with an NF of the O-Cloud. Said NF may be the target NF to be healed/recovered via the healing operation, and the associated parameter may include a type of the target NF (e.g., O-DU, O-CU-UP, etc.), a name/title of the target NF, and the like. It is contemplated that, when any other suitable entity or component is involved, the scope identifier may also include the parameter associated therewith.

According to example embodiments, the policy objective of the healing policy may include a healing objective. This healing objective may include at least one parameter associated with the healing operation. According to example embodiments, the healing objective may include at least one of: a parameter (e.g., a state description such as “Enable”/“Disable” or “Y”/“N”, a Boolean value such as “True”/“False”, etc.) defining whether or not the healing operation is enabled when one or more conditions defined in the healing objective are violated, and a parameter (e.g., name, title, ID, etc.) that defines the type of the healing operation (e.g., rebooting the NF specified in the scope identifier, redeploying the NF, etc.)

According to example embodiments, the policy resource of the healing policy may include a healing resource. In this regard, the healing resource may include at least one parameter associated with a condition for triggering or executing the healing operation. For instance, the healing resource may include a parameter describing one or more conditions (e.g., workload crashes, node unhealthy, etc.), a parameter associated with a performance metric (e.g., CPU utilization, memory utilization, storage utilization, etc.), or a combination thereof.

Referring next to the following Table 8, which presents an example energy-saving policy.

TABLE 8
Example Healing Policy

```
# Healing Policy
{
  ″policy_id″: “1″,
  “Scope”: {
  ″Controller″ : ″NFO″
  ″ NFType ″ : ″O-CU-UP″
},
“healingObjectives” : {
        “NFHealing” =“Enable”
        “HealingAction1”=“Reboot”
}
  “healingResources”: [
  { ″condition″: ″workload_crashed“
    ″condition″: ″node_unhealthy″
    }
]
“healingObjectives” : {
        “NFHealing” =“Enable”
        “HealingAction1”=“Redeploy”
}
  “healingResources”: [
  { ″metric″: ″cpu_utilization″
      ″condition″: ″workload_crashed“
      ″condition″: ″node_unhealthy″
    }
  ]
}
```

Similar to the example policies in Tables 4-7, the scope identifier of the example policy in Table 8 also includes information of the target controller (i.e., the name “NFO”) which can enforce or execute the policy. In addition, the example policy in Table 8 may also include information of the type of the target NF (i.e., O-CU-UP).

Further, the example policy in Table 8 includes multiple healing objectives, each of which includes a state description “Enable” that defines that an associated healing operation (i.e., rebooting, redeploying) should be executed when one or more conditions defined in the healing resources are violated. Furthermore, the example policy in Table 8 includes multiple healing resources, each of which includes a condition (e.g., workload crashes, node unhealthy, CPU utilization, etc.) In the first group of healing objectives and healing resources, the rebooting operation is enabled and will be triggered/executed whenever one or more NFs of the O-CU-UP experiences workload crashes and a node unhealthy is detected. In the second group of healing objectives and healing resources, the redeploying operation is enabled and will be triggered/executed whenever one or more NFs of the O-CU-UP experiences abnormal CPU utilization, workload crashes, and a node unhealthy is detected

FIG. 7 illustrates a flow diagram of an example use case in which a healing policy is involved in a healing operation, according to one or more example embodiments. In this example use case, the example healing policy in Table 7 may be involved. Further, it is contemplated that the enforcement and execution of other types of policy (e.g., capacity policy, scaling policy, energy-saving policy, etc.) may also be enforced or executed in a similar manner as described herein.

Referring to FIG. 7, at step S710, the Non-RT RIC (or the rApp implemented therein) may be configured to collect data associated with the O-Cloud, such as the NF performance, configuration, NF-related resource consumption, data volume consumption, and the like. These data may be collected from the O-Cloud via the O2 interface, and/or from one or more RAN network functions (e.g., O-CU, O-DU, etc.) via the O1 interface. Upon collecting the data, the Non-RT RIC (or the rApp implemented therein) may be configured to correlate the data and create/predict a trend for detecting the requirement of healing operation. For instance, the Non-RT RIC (or the rApp implemented therein) may create or update the healing policy based on the latest NF performance configuration and requirement.

Subsequently, at step S720, the Non-RT RIC (or the rApp implemented therein) may be configured to communicate with at least one controller (e.g., NFO, FOCOM, etc.) to discover the policy supported by the controller and query for the specific policy related details. In response, the controller may provide requested information such that the Non-RT RIC (or the rApp implemented therein) may utilize said information to create the policy. In some example embodiments, the information may include information of a policy schema. Further, in some example implementations where the controller (e.g., NFO, FOCOM, etc.) has registered the policy related capabilities to the SME and has created/registered the supported policy types with the PMI, the Non-RT RIC (or the rApp implemented therein) may be configured to obtain the information of the policy related capabilities of the controller from the SME, and obtain the information of the policy types supported by the controller from the PMI. Upon receiving the required information, the Non-RT RIC (or the rApp implemented therein) may design the policy based on, for example, datatypes of objectives, statements discovered during the procedure, and the like.

Next, at step S730, the Non-RT RIC (or the rApp implemented therein) may be configured to create or update the policy, and then provide the policy to the controller (e.g., NFO, FOCOM, etc.) for execution. According to example implementations where the controller (e.g., NFO, FOCOM, etc.) has registered the policy related capabilities to the SME and has created/registered the supported policy types with the PMI, the Non-RT RIC (or the rApp implemented therein) may be configured to interoperate with the SME and/or the PMI to create or update the policy. For instance, the Non-RT RIC (or the rApp implemented therein) may create or update the policy with the PMI, and the PMI may allocate the created/updated policy to the NFO and/or the FOCOM based on the scope defined in the policy.

At step S740, the controller (e.g., NFO, FOCOM, etc.) may be configured to evaluate the policy before executing it. For instance, the controller may consume the policy and detect whether or not the policy will cause any conflict with other existing policies. Further, the controller may verify the current state and health of resources as per condition. Accordingly, the controller may enforce the policy if no potential conflict is detected (or the detected conflict can be resolved) and the state of the resources allows the enforcement of the policy. On the other hand, the controller may reject the policy if any detected conflict cannot be resolved and/or if the state of resources does not allow the enforcement of the policy.

Subsequently, at step S750, the controller may be configured to enforce the policy (if applicable). For instance, in accordance to the O2DMS K8S profile, the controller may redeploy the workload and restart a pod based on conditions and metrics defined in the healing policy received from the Non-RT RIC (or the rAPP) at step S730. As another example, in accordance to the O2DMS ETSI NFVI profile, the controller may choose to activate auto-healing at DMS on multiple NFs. Accordingly, the DMS may monitor the conditions/metrics defined in the healing policy and then trigger the appropriate healing operation (e.g., restarting or rebooting NFs, etc.) thereafter. Upon enforcing the policy, the controller may collect feedback of the execution of the policy (e.g., successful, failed, etc.), and then notify the Non-RT RIC (or the rApp implemented therein) accordingly. Thereafter, the flow may be ended, or may proceed to alternative step S760.

At step S760, upon receiving a notification of successful policy enforcement from the controller, the Non-RT RIC (or the rApp implemented therein) may be configured to monitor the NF Fault Management (NF FM) and NF Performance Management (NF PM), and then guide the controller accordingly. For instance, the Non-RT RIC (or the rApp implemented therein) may perform further data collection and healing requirement prediction (i.e., return to strep S710), or may create a new healing policy or update an existing policy (i.e., return to step S730) based on the monitoring outcome. According to example implementations, the Non-RT RIC (or the rApp implemented therein) may be configured to interoperate the PMI to create or update the policy. For instance, the Non-RT RIC (or the rApp implemented therein) may monitor the NF FM and/or the NF PM, and then update the policy with the PMI. Accordingly, the PMI may update the NFO and/or the FOCOM regarding the same.

In view of the above, example embodiments of the present disclosure leverage the Non-RT RIC to facilitate the provisioning of the healing policy, and said healing policy may be executable by a controller (e.g., NFO, FOCOM, etc.) associated with the O-Cloud to automatically and dynamically perform appropriate healing operation to remediate any issues or failures in the O-Cloud. To this end, example embodiments of the present disclosure may enable automated healing of the O-Cloud, thereby ensuring high availability and resiliency of the O-Cloud, minimizing downtime and service disruptions.

In view of the above, example embodiments of the present disclosure introduce mechanisms for provisioning various types of O-Cloud policies, each of which may be utilized to enhance various aspects of O-Cloud. In this regard, it can be understood that the above-described O-Cloud policies (in Tables 3-8) are merely examples of possible configurations, and the contents thereof are simplified for descriptive purposes. In the actual implementations, the O-Cloud policies may include more or less information, and/or the contents therein may be arranged in a different manner, without departing from the scope of the present disclosure.

### Example Operations for Provisioning an O-Cloud Policy

As described above, example embodiments of the present disclosure facilitate the provisioning of at least one policy for managing and orchestrating an O-Cloud. Example operations associated therewith are described in the following.

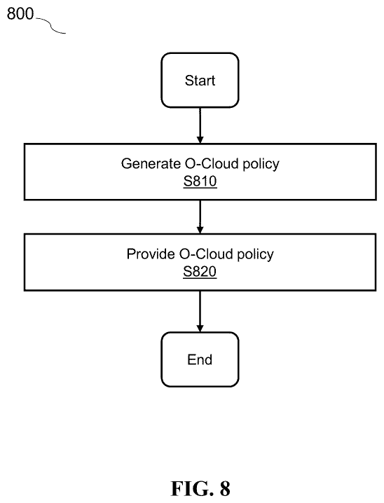

FIG. 8 illustrates a flow diagram of an example method 800 for provisioning one or more O-Cloud policies, according to one or more example embodiments. One or more operations of the method 800 may be performed by a Non-RT RIC (e.g., the Non-RT RIC 111 described above with reference to FIG. 1, etc.) In some example implementations in which the Non-RT RIC is implemented in a hardware (e.g., a server, a device, etc.), one or more operations of the method 800 may be performed by a component of the hardware (e.g., a processor of the server upon executing computer-readable instruction stored in a memory of the server, etc.) Further, the Non-RT RIC may also be configured to implement (e.g., execute, instruct, etc.) at least one rApp to perform one or more operations described herein.

Referring to FIG. 8, at operation S810, the Non-RT RIC (or the associated rApp) may be configured to generate an O-Cloud policy (i.e., a policy associated with the O-Cloud). The policy may be executable by at least one controller, such as an NFO, a FOCOM, a combination thereof, and the like. According to example embodiments, the Non-RT RIC (or the associated rApp) may be configured to interoperate with an SME and/or a PMI to generate the policy. For instance, the Non-RT RIC (or the associated rApp) may generate the policy with the SME/PMI.

As described above with reference to FIG. 7, the Non-RT RIC (or the associated rApp) may be configured to generate the policy by: collecting data associated with the current status of the O-Cloud, determining a requirement for orchestrating and managing the O-Cloud (e.g., a requirement for adjusting the capacity of the O-Cloud, a requirement for scaling the O-Cloud, a requirement for saving energy of the O-Cloud, and a requirement for healing the O-Cloud), obtaining (from the controller such as the NFO and/or the FOCOM) information of a policy type supported by the controller, and creating the policy based on the requirement(s) and the supported policy type. Further details regarding the specific operations for creating the policy have been provided above with reference to FIG. 1 to FIG. 7. Thus, redundant descriptions associated therewith may be omitted below for conciseness.

As also described above, the policy may include at least one of: a capacity policy defining a resource management operation associated with the O-Cloud, a scaling policy defining a scaling operation associated with the O-Cloud, an energy-saving policy defining an energy-saving operation associated with the O-Cloud and a healing policy defining a healing operation associated with the O-Cloud.

The capacity policy may include at least one scope identifier, at least one capacity objective, and at least one capacity resource. The scope identifier may include a first parameter associated with the at least one of the NFO and FOCOM. For instance, the first parameter may include at least one of: an identifier (ID) of the at least one of the NFO and FOCOM, and a name of the at least one of the NFO and FOCOM. The capacity objective may include a second parameter associated with a target capacity of the O-Cloud. For instance, the second parameter may include a target resource allocation to a network function (NF) associated with the O-Cloud. The capacity resource may include a third parameter associated at least one of: an O-Cloud node to which the resource management operation can be applied (or should be applied), and an O-Cloud node that can be excluded (or should be excluded) from the resource management operation. In some example embodiments, the third parameter may be associated with at least one of: an inclusion list including information of a plurality of O-Cloud nodes to which the resource management can be applied (or should be applied), and an exclusion list including information of a plurality of O-Cloud nodes that can be excluded (or should be excluded) from the resource management operation.

The scaling policy may include at least one of scope identifier, at least one scaling objective, and at least one scaling resource. The scope identifier may include a first parameter associated with the at least one of the NFO and FOCOM. For instance, the first parameter may include such as at least one of: an ID of the at least one of the NFO and FOCOM, and a name of the at least one of the NFO and FOCOM. The scaling objective may include a second parameter associated with a target scale of the O-Cloud. For instance, the second parameter may include at least one of: a parameter defining whether or not the scaling operation is enabled, a parameter defining a condition for executing the scaling operation, and a parameter defining a condition for terminating the scaling operation. The scaling resource may include a third parameter associated with the scaling operation. For instance, the third parameter may include at least one of: a start time for executing the scaling policy, an end time for terminating the execution of the scaling policy, and a cool down time after terminating the execution of the scaling policy.

According to example embodiments, the scaling policy may include a network function (NF) predictive auto-scaling policy. In this regard, the parameter defining the condition for executing the scaling operation (included in the scaling objective) may include at least one of: a parameter defining a maximum utilization of a resource, and a parameter defining a minimum utilization of the resource. Further, the scaling resource may further include at least one of: a step size for increasing an instance of an NF of the O-Cloud and a step size for decreasing the instance of the NF.

According to example embodiments, the scaling policy may include an NF scheduled auto-scaling policy. In this regard, the parameter defining the condition for executing the scaling operation (included in the scaling objective) may include at least one of: a parameter defining the minimum size of an auto-scaling group, a parameter defining the maximum size of the auto-scaling group, and a parameter defining a desired size of the auto-scaling group.

On the other hand, the energy-saving policy may include at least one scope identifier, at least one energy-saving objective, and at least one energy-saving resource. The scope identifier may include a first parameter associated with the at least one of the NFO and FOCOM. For instance, the first parameter may include at least one of: an ID of the at least one of the NFO and FOCOM, and a name of the at least one of the NFO and FOCOM. The energy-saving objective may include a second parameter associated with the energy-saving operation. For instance, the second parameter may include a parameter defining whether or not the energy-saving operation is enabled, a parameter defining a condition for executing the energy-saving operation, and a parameter defining a duration of the execution of the energy-saving operation. The energy-saving resource may include a third parameter associated at least one of: an O-Cloud node to which the resource management operation can be applied (or should be applied), and an O-Cloud node that can be excluded (or should be excluded) from the resource management operation. In some example embodiments, the third parameter may associate with at least one of: an inclusion list including information of a plurality of O-Cloud nodes to which the energy-saving operation can be applied (or should be applied), and an exclusion list including information of a plurality of O-Cloud nodes that can be excluded (or should be excluded) from the energy-saving operation.

Further, the healing policy may include at least one scope identifier, at least one healing objective, and at least one healing resource. The scope identifier may include a first parameter associated with the at least one of the NFO and FOCOM. For instance, the first parameter may include at least one of: an ID of the at least one of the NFO and FOCOM, and a name of the at least one of the NFO and FOCOM. In addition, the scope identifier may also include a second parameter associated with an NF of the O-Cloud. For instance, the second parameter may include at least one of: a type of the NF, and a name/title of the NF. The healing objective may include a third parameter associated with the healing operation. For instance, the third parameter may include a parameter defining whether or not the healing operation is enabled, and a parameter defining the type of the healing operation. The healing resource may include a fourth parameter associated at least one condition for triggering the healing operation.

Referring still to FIG. 8, upon generating the policy, the method 800 may proceed to operation S820, at which the Non-RT RIC (or the associated rApp) may be configured to provide the policy to at least one of the NFO and FOCOM. Accordingly, the NFO and/or FOCOM may execute or enforce the policy to provide O-Cloud orchestration and management. According to embodiments, the Non-RT RIC (or the associated rApp) may be configured to interoperate with the SME/PMI to provide the policy to the NFO and/or the FOCOM. For instance, in the case that the Non-RT RIC (or the associated rApp) generates the policy with the PMI, the PMI may provide the generated policy to the NFO/FOCOM based on the scope mentioned in the policy.

Further descriptions of each of the capacity policy, scaling policy, energy-saving policy, and healing policy, as well as the operations and communications of the Non-RT RIC (or the rApp) and the controller (e.g., NFO, FOCOM, etc.), have been provided above with reference to at least FIG. 1-FIG. 7. Thus, redundant descriptions associated therewith may be omitted below for conciseness.

In view of the above, example embodiments of the present disclosure effectively and efficiently facilitate the provisioning of one or more O-Cloud policies with the Non-RT RIC. The provided one or more policies may act as a set of rules and conditions that trigger a respective action or configuration. Ultimately, example embodiments of the present disclosure enable automated decision-making in the cloud environment, provide dynamic adjustments on the scale of the cloud environment, integrate automated self-healing mechanisms to enhance the resiliency of the cloud environment, and incorporate energy-saving mechanisms to optimize the power consumption and efficiency of the cloud environment.

Further, the provided one or more policies may enable operator-driven O-Cloud orchestration and management, allowing the network operators to set the rules or conditions according to the requirements. In addition, aligning multiple types of controllers, such as NFO and FOCOM, with operator requirements akin to RAN resources governed by the policies, fosters an open environment. Accordingly, the example embodiments of the present disclosure empower operators, enhance agility, and promote efficient network management.

### Examples of Hardware Components

One or more components of the system of the example embodiments (e.g., Non-RT RIC, NFO, FOCOM, etc.), as well as the operations associated therewith, may be implemented in one or more systems, devices, or hardware components, such as one or more servers, and the like. In the following, descriptions of a device in which the systems or components of the example embodiments may be implemented are provided. It is contemplated that one or more features, operations, and methods described above with reference to FIG. 1 to FIG. 8 may be performed by the device. For instance, the one or more operations or methods may be performed by at least one processor of the device upon executing machine-readable instructions or computer-readable instructions (e.g., instructions for implementing the Non-RT RIC, etc.) stored in a memory or a storage component of the device.

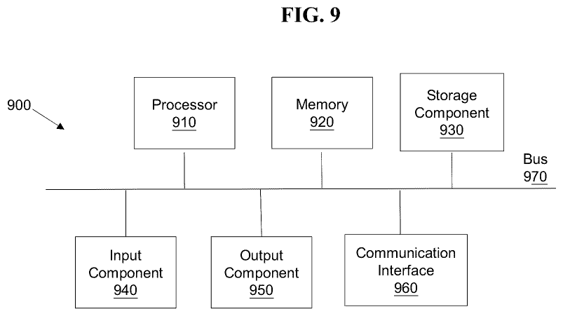

FIG. 9 illustrates an embodiment of a device 900. As shown in FIG. 9, the device 900 may include a processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, instructions to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

### Various Aspects of Embodiments

It is contemplated that the example embodiments described hereinabove with reference to FIG. 1 to FIG. 9 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., network node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system including: a non-real-time (Non-RT) radio access network (RAN) intelligent controller (RIC) configured to: generate a policy associated with an open-RAN cloud (O-Cloud), wherein the policy may be executable by at least one of a network function orchestrator (NFO) and a federated O-Cloud orchestration and management entity (FOCOM) for managing and orchestrating the O-Cloud; and provide the policy to at least one of the NFO and FOCOM. The policy may include at least one of: a capacity policy associated with a resource management operation associated with the O-Cloud, a scaling policy associated with a scaling operation associated with the O-Cloud, an energy-saving policy associated with an energy-saving operation associated with the O-Cloud and an healing policy associated with a healing operation associated with the O-Cloud.
Item [2]: The system according to item [1], the capacity policy may include: a scope identifier that includes a first parameter associated with the at least one of the NFO and FOCOM, wherein the first parameter includes at least one of: an identifier (ID) of the at least one of the NFO and FOCOM, and a name of the at least one of the NFO and FOCOM; a capacity objective that includes a second parameter associated with a target capacity of the O-Cloud, wherein the second parameter includes a target resource allocation to a network function (NF) associated with the O-Cloud; and a capacity resource that includes a third parameter associated at least one of: an O-Cloud node to which the resource management operation can be applied, and an O-Cloud node that can be excluded from the resource management operation.
Item [3]: The system according to any one of items [1]-[2], wherein the scaling policy may include: a scope identifier that includes a first parameter associated with the at least one of the NFO and FOCOM, wherein the first parameter includes at least one of: an ID of the at least one of the NFO and FOCOM, and a name of the at least one of the NFO and FOCOM; a scaling objective that includes a second parameter associated with a target scale of the O-Cloud, wherein the second parameter includes at least one of: a parameter defining whether or not the scaling operation is enabled, a parameter defining a condition for executing the scaling operation, and a parameter defining a condition for terminating the scaling operation; and a scaling resource that includes a third parameter associated with the scaling operation, wherein the third parameter includes at least one of: a start time for executing the scaling policy, an end time for terminating the execution of the scaling policy, and a cool down time after terminating the execution of the scaling policy.
Item [4]: The system according to any one of items [1]-[3], wherein the energy-saving policy includes: a scope identifier that includes a first parameter associated with the at least one of the NFO and FOCOM, wherein the first parameter includes at least one of: an ID of the at least one of the NFO and FOCOM, and a name of the at least one of the NFO and FOCOM; an energy-saving objective that includes a second parameter associated with the energy-saving operation, wherein the second parameter includes at least one of: a parameter defining whether or not the energy-saving operation is enabled, a parameter defining a condition for executing the energy-saving operation, and a parameter defining a duration of the execution of the energy-saving operation; and an energy-saving resource that includes a third parameter associated at least one of: an O-Cloud node to which the energy-saving operation can be applied, and an O-Cloud node that can be excluded from the energy-saving operation.
Item [5]: The system according to any one of items [1]-[4], wherein the healing policy includes: a scope identifier that includes a first parameter associated with the at least one of the NFO and FOCOM and a second parameter associated with an NF of the O-Cloud, wherein the first parameter includes at least one of: an ID of the at least one of the NFO and FOCOM, and a name of the at least one of the NFO and FOCOM, and wherein the second parameter includes at least one of: a type of the NF, and a name/title of the NF; a healing objective that includes a third parameter associated with the healing operation, wherein the third parameter includes at least one of: a parameter defining whether or not the healing operation is enabled, and a parameter defining the type of the healing operation; and a healing resource that includes a fourth parameter associated with a condition for triggering the healing operation.
Item [6]: The system according to item [3], wherein the scaling policy includes a network function (NF) predictive auto-scaling policy; wherein the parameter defining the condition for executing the scaling operation includes at least one of: a parameter defining a maximum utilization of a resource, and a parameter defining a minimum utilization of the resource; and wherein the scaling resource further includes at least one of: a step size for increasing an instance of an NF of the O-Cloud and a step size for decreasing the instance of the NF.
Item [7]: The system according to item [3], wherein the scaling policy includes an NF scheduled auto-scaling policy; and wherein the parameter defining the condition for executing the scaling operation includes at least one of: a parameter defining minimum size of an auto-scaling group, a parameter defining a maximum size of the auto-scaling group, and a parameter defining a desired size of the auto-scaling group.
Item [8]: The system according to any one of items [1]-[7], wherein the Non-RT RIC may be configured to generate the policy by: collecting data associated with a current status of the O-Cloud; determining, based on the collected data, a requirement for orchestrating and managing the O-Cloud, wherein the requirement includes at least one of: a requirement for adjusting the capacity of the O-Cloud, a requirement for scaling the O-Cloud, a requirement for saving energy of the O-Cloud, and a requirement for healing the O-Cloud; obtaining information of a policy type supported by the at least one of the NFO and the FOCOM; and creating, based on the requirement and the supported policy type, the policy.
Item [9]: The system according to item [8], wherein the Non-RT RIC may be configured to obtain the information of the supported policy type from at least one of: the NFO, the FOCOM, a service management and exposure (SME) entity, and a policy management and information (PMI) entity.
Item [10]: A method including: generating a policy associated with an open-RAN cloud (O-Cloud), wherein the policy may be executable by at least one of a network function orchestrator (NFO) and a federated O-Cloud orchestration and management entity (FOCOM) for managing and orchestrating the O-Cloud; and providing the policy to at least one of the NFO and FOCOM. The policy may include at least one of: a capacity policy associated with a resource management operation associated with the O-Cloud, a scaling policy associated with a scaling operation associated with the O-Cloud, an energy-saving policy associated with an energy-saving operation associated with the O-Cloud and an healing policy associated with a healing operation associated with the O-Cloud.
Item [11]: The method according to item [10], the capacity policy may include: a scope identifier that includes a first parameter associated with the at least one of the NFO and FOCOM, wherein the first parameter includes at least one of: an identifier (ID) of the at least one of the NFO and FOCOM, and a name of the at least one of the NFO and FOCOM; a capacity objective that includes a second parameter associated with a target capacity of the O-Cloud, wherein the second parameter includes a target resource allocation to a network function (NF) associated with the O-Cloud; and a capacity resource that includes a third parameter associated at least one of: an O-Cloud node to which the resource management operation can be applied, and an O-Cloud node that can be excluded from the resource management operation.
Item [12]: The method according to any one of items [10]-[11], wherein the scaling policy may include: a scope identifier that includes a first parameter associated with the at least one of the NFO and FOCOM, wherein the first parameter includes at least one of: an ID of the at least one of the NFO and FOCOM, and a name of the at least one of the NFO and FOCOM; a scaling objective that includes a second parameter associated with a target scale of the O-Cloud, wherein the second parameter includes at least one of: a parameter defining whether or not the scaling operation is enabled, a parameter defining a condition for executing the scaling operation, and a parameter defining a condition for terminating the scaling operation; and a scaling resource that includes a third parameter associated with the scaling operation, wherein the third parameter includes at least one of: a start time for executing the scaling policy, an end time for terminating the execution of the scaling policy, and a cool down time after terminating the execution of the scaling policy.
Item [13]: The method according to any one of items [10]-[12], wherein the energy-saving policy includes: a scope identifier that includes a first parameter associated with the at least one of the NFO and FOCOM, wherein the first parameter includes at least one of: an ID of the at least one of the NFO and FOCOM, and a name of the at least one of the NFO and FOCOM; an energy-saving objective that includes a second parameter associated with the energy-saving operation, wherein the second parameter includes at least one of: a parameter defining whether or not the energy-saving operation is enabled, a parameter defining a condition for executing the energy-saving operation, and a parameter defining a duration of the execution of the energy-saving operation; and an energy-saving resource that includes a third parameter associated at least one of: an O-Cloud node to which the energy-saving operation can be applied, and an O-Cloud node that can be excluded from the energy-saving operation.
Item [14]: The method according to any one of items [10]-[13], wherein the healing policy includes: a scope identifier that includes a first parameter associated with the at least one of the NFO and FOCOM and a second parameter associated with an NF of the O-Cloud, wherein the first parameter includes at least one of: an ID of the at least one of the NFO and FOCOM, and a name of the at least one of the NFO and FOCOM, and wherein the second parameter includes at least one of: a type of the NF, and a name/title of the NF; a healing objective that includes a third parameter associated with the healing operation, wherein the third parameter includes at least one of: a parameter defining whether or not the healing operation is enabled, and a parameter defining the type of the healing operation; and a healing resource that includes a fourth parameter associated with a condition for triggering the healing operation.
Item [15]: The method according to item [12], wherein the scaling policy includes a network function (NF) predictive auto-scaling policy; wherein the parameter defining the condition for executing the scaling operation includes at least one of: a parameter defining a maximum utilization of a resource, and a parameter defining a minimum utilization of the resource; and wherein the scaling resource further includes at least one of: a step size for increasing an instance of an NF of the O-Cloud and a step size for decreasing the instance of the NF.
Item [16]: The method according to item [12], wherein the scaling policy includes an NF scheduled auto-scaling policy; and wherein the parameter defining the condition for executing the scaling operation includes at least one of: a parameter defining minimum size of an auto-scaling group, a parameter defining a maximum size of the auto-scaling group, and a parameter defining a desired size of the auto-scaling group.
Item [17]: The method according to any one of items [10-]-[16], wherein the Non-RT RIC may be configured to generate the policy by: collecting data associated with a current status of the O-Cloud; determining, based on the collected data, a requirement for orchestrating and managing the O-Cloud, wherein the requirement includes at least one of: a requirement for adjusting the capacity of the O-Cloud, a requirement for scaling the O-Cloud, a requirement for saving energy of the O-Cloud, and a requirement for healing the O-Cloud; obtaining, from the at least one of the NFO and the FOCOM, information of a policy type supported by the at least one of the NFO and the FOCOM; and creating, based on the requirement and the supported policy type, the policy.
Item [18]: The method according to item [17], wherein the obtaining the information of the supported policy type may include: obtaining the information of the supported policy type from at least one of: the NFO, the FOCOM, a service management and exposure (SME) entity, and a policy management and information (PMI) entity.
Item [19]: A non-transitory computer-readable recording medium having recorded thereon instructions executable by a system that comprises a non-real-time (Non-RT) radio access network intelligent controller (RIC) to cause the Non-RT RIC to perform a method including: generating a policy associated with an open-RAN cloud (O-Cloud), wherein the policy may be executable by at least one of a network function orchestrator (NFO) and a federated O-Cloud orchestration and management entity (FOCOM) for managing and orchestrating the O-Cloud; and providing the policy to at least one of the NFO and FOCOM. The policy may include at least one of: a capacity policy associated with a resource management operation associated with the O-Cloud, a scaling policy associated with a scaling operation associated with the O-Cloud, an energy-saving policy associated with an energy-saving operation associated with the O-Cloud and an healing policy associated with a healing operation associated with the O-Cloud.
Item [20]: The non-transitory computer-readable recording medium according to item [19], the capacity policy may include: a scope identifier that includes a first parameter associated with the at least one of the NFO and FOCOM, wherein the first parameter includes at least one of: an identifier (ID) of the at least one of the NFO and FOCOM, and a name of the at least one of the NFO and FOCOM; a capacity objective that includes a second parameter associated with a target capacity of the O-Cloud, wherein the second parameter includes a target resource allocation to a network function (NF) associated with the O-Cloud; and a capacity resource that includes a third parameter associated at least one of: an O-Cloud node to which the resource management operation can be applied, and an O-Cloud node that can be excluded from the resource management operation.

It can be understood that numerous modifications and variations of the present disclosure are possible in light of the above teachings. It will be apparent that within the scope of the appended clauses, the present disclosures may be practiced otherwise than as specifically described herein.

1.-20. (canceled)

21. A system comprising:
a non-real-time (Non-RT) radio access network (RAN) intelligent controller (RIC) configured to:
generate a policy associated with an open-RAN cloud (O-Cloud), wherein the policy is executable by at least one of a network function orchestrator (NFO) and a federated O-Cloud orchestration and management entity (FOCOM) for managing and orchestrating the O-Cloud; and
provide the policy to at least one of the NFO and FOCOM,
wherein the policy comprises at least one of: a capacity policy associated with a resource management operation associated with the O-Cloud, a scaling policy associated with a scaling operation associated with the O-Cloud, an energy-saving policy associated with an energy-saving operation associated with the O-Cloud and a healing policy associated with a healing operation associated with the O-Cloud.

22. The system according to claim 21, wherein the Non-RT RIC is configured to generate the policy by:
collecting data associated with a current status of the O-Cloud;
determining, based on the collected data, a requirement for orchestrating and managing the O-Cloud, wherein the requirement comprises at least one of: a requirement for adjusting the capacity of the O-Cloud, a requirement for scaling the O-Cloud, a requirement for saving energy of the O-Cloud, and a requirement for healing the O-Cloud;
obtaining information associated with at least one of: a policy type supported by the at least one of the NFO and the FOCOM, and policy related capabilities of the at least one of the NFO and the FOCOM; and
creating, based on the requirement and the obtained information, the policy.

23. The system according to claim 22, wherein the Non-RT RIC is configured to obtain the information from at least one of: the NFO, the FOCOM, a service management and exposure (SME) entity, and a policy management and information (PMI) entity.

24. The system according to claim 21, wherein the Non-RT RIC is configured to generate the policy with a PMI entity.

25. The system according to claim 21, wherein the Non-RT RIC is configured to provide, via a PMI entity, the policy to the at least one of the NFO and FOCOM.

26. The system according to claim 21, wherein the Non-RT RIC is further configured to:
perform monitoring based on at least one of performance management (PM) and fault management (FM); and
update, based on the monitoring, the policy with a PMI entity.

27. The system according to claim 21, wherein the capacity policy comprises:
a scope identifier that comprises a first parameter associated with the at least one of the NFO and FOCOM, wherein the first parameter comprises at least one of: an identifier (ID) of the at least one of the NFO and FOCOM, and a name of the at least one of the NFO and FOCOM;
a capacity objective that comprises a second parameter associated with a target capacity of the O-Cloud, wherein the second parameter comprises a target resource allocation to a network function (NF) associated with the O-Cloud; and
a capacity resource that comprises a third parameter associated at least one of: an O-Cloud node to which the resource management operation can be applied, and an O-Cloud node that can be excluded from the resource management operation.

28. The system according to claim 21, wherein the scaling policy comprises:
a scope identifier that comprises a first parameter associated with the at least one of the NFO and FOCOM, wherein the first parameter comprises at least one of: an ID of the at least one of the NFO and FOCOM, and a name of the at least one of the NFO and FOCOM;
a scaling objective that comprises a second parameter associated with a target scale of the O-Cloud, wherein the second parameter comprises at least one of: a parameter defining whether or not the scaling operation is enabled, a parameter defining a condition for executing the scaling operation, and a parameter defining a condition for terminating the scaling operation; and
a scaling resource that comprises a third parameter associated with the scaling operation, wherein the third parameter comprises at least one of: a start time for executing the scaling policy, an end time for terminating the execution of the scaling policy, and a cool down time after terminating the execution of the scaling policy.

29. The system according to claim 21, wherein the energy-saving policy comprises:
a scope identifier that comprises a first parameter associated with the at least one of the NFO and FOCOM, wherein the first parameter comprises at least one of: an ID of the at least one of the NFO and FOCOM, and a name of the at least one of the NFO and FOCOM;
an energy-saving objective that comprises a second parameter associated with the energy-saving operation, wherein the second parameter comprises at least one of: a parameter defining whether or not the energy-saving operation is enabled, a parameter defining a condition for executing the energy-saving operation, and a parameter defining a duration of the execution of the energy-saving operation; and
an energy-saving resource that comprises a third parameter associated at least one of: an O-Cloud node to which the energy-saving operation can be applied, and an O-Cloud node that can be excluded from the energy-saving operation.

30. A method comprising:
generating a policy associated with an open-RAN cloud (O-Cloud), wherein the policy is executable by at least one of a network function orchestrator (NFO) and a federated O-Cloud orchestration and management entity (FOCOM) for managing and orchestrating the O-Cloud; and
providing the policy to at least one of the NFO and FOCOM,
wherein the policy comprises at least one of: a capacity policy associated with a resource management operation associated with the O-Cloud, a scaling policy associated with a scaling operation associated with the O-Cloud, an energy-saving policy associated with an energy-saving operation associated with the O-Cloud and a healing policy associated with a healing operation associated with the O-Cloud.

31. The method according to claim 30, wherein the generating the policy comprises:
collecting data associated with a current status of the O-Cloud;
determining, based on the collected data, a requirement for orchestrating and managing the O-Cloud, wherein the requirement comprises at least one of: a requirement for adjusting the capacity of the O-Cloud, a requirement for scaling the O-Cloud, a requirement for saving energy of the O-Cloud, and a requirement for healing the O-Cloud;
obtaining information associated with at least one of: a policy type supported by the at least one of the NFO and the FOCOM, and policy related capabilities of the at least one of the NFO and the FOCOM; and
creating, based on the requirement and the obtained information, the policy.

32. The method according to claim 31, wherein the obtaining the information comprises: obtaining the information at least one of: the NFO, the FOCOM, a service management and exposure (SME) entity, and a policy management and information (PMI) entity.

33. The method according to claim 30, wherein the generating the policy comprises:
generating the policy with a PMI entity.

34. The method according to claim 30, wherein the providing the policy comprises:
providing, via a PMI entity, the policy to the at least one of the NFO and FOCOM.

35. The method according to claim 30, wherein the method further comprises:
performing monitoring based on at least one of performance management (PM) and fault management (FM); and
updating, based on the monitoring, the policy with a PMI entity.

36. The method according to claim 30, wherein the capacity policy comprises:
a scope identifier that comprises a first parameter associated with the at least one of the NFO and FOCOM, wherein the first parameter comprises at least one of: an identifier (ID) of the at least one of the NFO and FOCOM, and a name of the at least one of the NFO and FOCOM;
a capacity objective that comprises a second parameter associated with a target capacity of the O-Cloud, wherein the second parameter comprises a target resource allocation to a network function (NF) associated with the O-Cloud; and
a capacity resource that comprises a third parameter associated at least one of: an O-Cloud node to which the resource management operation can be applied, and an O-Cloud node that can be excluded from the resource management operation.

37. The method according to claim 30 wherein the scaling policy comprises:
a scope identifier that comprises a first parameter associated with the at least one of the NFO and FOCOM, wherein the first parameter comprises at least one of: an ID of the at least one of the NFO and FOCOM, and a name of the at least one of the NFO and FOCOM;
a scaling objective that comprises a second parameter associated with a target scale of the O-Cloud, wherein the second parameter comprises at least one of: a parameter defining whether or not the scaling operation is enabled, a parameter defining a condition for executing the scaling operation, and a parameter defining a condition for terminating the scaling operation; and
a scaling resource that comprises a third parameter associated with the scaling operation, wherein the third parameter comprises at least one of: a start time for executing the scaling policy, an end time for terminating the execution of the scaling policy, and a cool down time after terminating the execution of the scaling policy.

38. The method according to claim 30, wherein the energy-saving policy comprises:
a scope identifier that comprises a first parameter associated with the at least one of the NFO and FOCOM, wherein the first parameter comprises at least one of: an ID of the at least one of the NFO and FOCOM, and a name of the at least one of the NFO and FOCOM;
an energy-saving objective that comprises a second parameter associated with the energy-saving operation, wherein the second parameter comprises at least one of: a parameter defining whether or not the energy-saving operation is enabled, a parameter defining a condition for executing the energy-saving operation, and a parameter defining a duration of the execution of the energy-saving operation; and
an energy-saving resource that comprises a third parameter associated at least one of: an O-Cloud node to which the energy-saving operation can be applied, and an O-Cloud node that can be excluded from the energy-saving operation.

39. A non-transitory computer-readable recording medium having recorded thereon instructions executable by a system that comprises a non-real-time (Non-RT) radio access network intelligent controller (RIC) to cause the Non-RT RIC to perform a method comprising:
generating a policy associated with an open-RAN cloud (O-Cloud), wherein the policy is executable by at least one of a network function orchestrator (NFO) and a federated O-Cloud orchestration and management entity (FOCOM) for managing and orchestrating the O-Cloud; and
providing the policy to at least one of the NFO and FOCOM,
wherein the policy comprises at least one of: a capacity policy associated with a resource management operation associated with the O-Cloud, a scaling policy associated with a scaling operation associated with the O-Cloud, an energy-saving policy associated with an energy-saving operation associated with the O-Cloud and a healing policy associated with a healing operation associated with the O-Cloud.

40. The non-transitory computer-readable recording medium according to claim 39, wherein the generating the policy comprises:
collecting data associated with a current status of the O-Cloud;
determining, based on the collected data, a requirement for orchestrating and managing the O-Cloud, wherein the requirement comprises at least one of: a requirement for adjusting the capacity of the O-Cloud, a requirement for scaling the O-Cloud, a requirement for saving energy of the O-Cloud, and a requirement for healing the O-Cloud;
obtaining information associated with at least one of: a policy type supported by the at least one of the NFO and the FOCOM, and policy related capabilities of the at least one of the NFO and the FOCOM; and
creating, based on the requirement and the obtained information, the policy.
